(19) United States
(12) Patent Application Publication
(10) Pub. No.: US 2024/0199445 A1
(43) Pub. Date: Jun. 20, 2024

(54) A Method Of Separation

(71) Applicant: Opec Remediation Technologies Pty Limited, Hornsby NSW (AU)

(72) Inventors: David John Burns, Hornsby (AU); Anthony Lindsay Morrison, Hornsby (AU)

(21) Appl. No.: 18/265,428

(22) PCT Filed: Dec. 3, 2021
(86) PCT No.: PCT/IB2021/061337

§ 371 Date: Dec. 12, 2023

(30) Foreign Application Priority Data
Dec. 3, 2020 (AU) 2020904480
Dec. 3, 2020 (AU) 2020904481

(51) Int. Cl. C02F 1/24; C02F 101/36

(52) U.S. Cl. CPC C02F 1/24; C02F 2101/36; C02F 2201/002

(57) ABSTRACT

A method of separating trace amounts of amphiphilic substances from water which is contaminated with the substances, the method comprising the steps of: admitting an amount of the water, which includes an initial concentration of the substances, into a chamber via an inlet thereinto: —introducing a flow of gas into the chamber, wherein said introduced gas induces the water in the chamber to flow, and produces a froth layer which is formed at, and which rises above, an interface with the said flow of—controlling the water content of the froth layer which rises above the interface to influence the concentration of the substances therein; and—removing at least some of the froth layer from an upper portion of the chamber.

### TECHNICAL FIELD

This disclosure relates to an apparatus for separation of a substance from water and to a method for use of the separation apparatus. In one form, the apparatus and method can be applied to removal of dilute contaminant organic material present in groundwater which has been extracted from a body of ground. However, the apparatus and method can also be applied to the removal of non-organic materials or contaminants from all types of contaminated water sources.

### BACKGROUND OF THE DISCLOSURE

Perfluoroalkyl or polyfluoroalkyl substances (PFAS) embody a range of poly fluorinated alkyl substances (including but not limited to carboxylic acids, alkyl sulfonates, alkyl sulfonamido compounds and fluoro telemeric compounds of differing carbon chain lengths and precursors of these). PFAS have found use in a wide variety of applications including as a specialised fire-fighting product, or for impregnation or coating of textiles, leather and carpet, or for carpet cleaning compounds, as well as in aviation hydraulic fluids, metal plating, agricultural (insect traps for certain types of ants), photo-imaging, electronics manufacture and non-stick cookware applications.

Higher order PFAS degrade to specific end-point PFAS chemicals (including but not limited to perfluorooctane sulfonate (PFOS), perfluorooctanoic acid (PFOA) and perfluorohexane sulfonate (PFHxS). These priority compounds of concern are resistant to biotic or abiotic degradation and thus are persistent in the environment. They are recalcitrant, bio-accumulative and known to have contaminated soils, groundwaters and drinking water supplies.

PFAS are known to have contaminated groundwater, including drinking water supplies. PFOS, PFHxS, and PFOA have published human health and environmental regulatory criteria in most developed world jurisdictions. Additional PFAS compounds are expected to be identified as contaminants of concern as new research toxicology data indicates potential risk associations. Remedial methods are needed to treat priority PFAS compounds.

Technology used to remove volatile organic compounds (VOC) by bubbling air through groundwater or in groundwater wells (also known as “air stripping”) is known in a number of publications. However, it is also known that such techniques do not work to treat groundwater with PFAS contamination. In a recent study, data is presented from a US location contaminated by PFAS where air-stripping had been previously used to remove VOCs, but more than 25 years after that activity, the site under investigation still had high, persistent PFAS contamination requiring remediation (Environ. Sci. Pollut. Res (2013) 20:1977-1992 pp). While they are soluble, most long-chain PFAS (including PFOS and PFOA have a low, to very low, vapour pressure, which means they do not volatilise easily, so air-stripping is therefore not an ineffective remedial treatment.

The use of conventional, cylindrical fractionation columns has been proven deployed to remove PFAS from impacted groundwater and surface waters arising from legacy fire-fighting foam formulations (such as 3M Lightwater), which are characterised by a higher long-chain/short-chain concentration ratio, with influent total detectable average PFAS concentration of between 3 μg/l to 9 μg/l.

Many environmental sites impacted by groundwater/surface water PFAS contamination are typically defined by total detectable PFAS concentrations in the range of 0.1-1 μg/l, representing trace, or ultra-low level, contamination. Ultra-trace level (<0.1 μg/l) PFAS-impacted waters (for example, drinking water and landfill leachate), and trace level (<1 μg/l) PFAS-impacted waters (for example, trade waste and off-site environmental groundwater/surface waters), require a primary fractionation process which can treat and remove sufficient PFAS mass from the aerated water column to achieve a foam which is able to be harvested, and then reprocessed using subsequent secondary/tertiary foam fractionation processes, to become further concentrated.

However, it has proven difficult to demonstrate the capability of foam fractionation with influent total detectable average PFAS concentration at trace levels (<1 μg/l) and at ultra-trace levels (<0.1 μg/l) when using the conventional cylindrical column geometries. An improved primary fractionation process and apparatus is needed to remove PFAS and to create a stable foam product.

### SUMMARY

In a first aspect there is provided a method of separating an amount of a substance from water which is contaminated with the substance, the method comprising the steps of: admitting an amount of the water, which includes an initial concentration of the substance, into a chamber via an inlet thereinto; introducing a flow of gas into the chamber, wherein said introduced gas induces the water in the chamber to flow, and produces a froth layer which is formed at, and which rises above, an interface with the said flow of water and of introduced gas in the chamber, the froth layer including an amount of water and also a concentrated amount of the substance when compared with its initial concentration; controlling the water content of the froth layer which rises above the interface to influence the concentration of the substance therein; and removing at least some of the froth layer from an upper portion of the chamber.

In certain embodiments, the flow of gas and the production of the froth layer is conducted in batch mode for specific treatment situations.

In some embodiments, the step of controlling the water content of the froth layer is by of the group comprising: controlling a physical parameter of the flow of introduced gas; and controlling a physical parameter of the froth layer.

In some embodiments, the step of controlling a physical parameter of the flow of introduced gas comprises use of a flow controller and an inlet valve for controlling the flow of said introduced gas into the chamber.

In some embodiments, the step of controlling a physical parameter of the flow of introduced gas comprises use of a bubble generation device located prior to, or at the point, when said introduced gas enters the water located in the chamber. Bubble generation devices can include air bubblers (or equivalent nomenclature such as spargers, frits, aerators, aeration diffusers, air stones and the like) located within the chamber and in contact with the water. Another type of bubble generation device can involve inducing air into a flow of water passing through a venturi expander for example, to create fine air bubbles in situ, and then passing this aerated flow into the chamber. This latter embodiment is employed by the present inventor for its ease and simplicity and as a way of maximising air delivery into the chamber.

In certain embodiments, the step of controlling a physical parameter of the froth layer further comprises use of a device for confining the cross-sectional flow path of the froth in the upper portion of the chamber, resulting in drainage of said froth layer. Apparatus which is shaped to confine or squeeze a rising froth layer can cause additional drainage of the froth layer, and may include changes to the cross-sectional open area of froth flow, for example by the use of froth crowders, narrow necked passages or channels or capillaries, tapered funnels, weir skimmers, for example.

In some embodiments, the froth layer is collapsed during said removal step from the upper portion of the chamber, and prior to undergoing a secondary treatment step. In one form of this, the froth layer is collapsed during said removal step from the upper portion of the chamber, and prior to undergoing a secondary treatment step.

In some examples, the froth layer is collapsed by using mechanical apparatus from the group comprising: a foam breaker, a vacuum extraction device, and a froth extraction head.

Froth depth regulation devices which are arranged at a fixed location within the chamber require constant adjustment of the location of the interface, which is readily changed by altering, for example, the flow of the introduced gas or by altering the relative rates of the water inflow/outflows (in a continuous process system). A liquid level sensor can signal whether the water level is too high or too low, and control the flow of the introduced gas or water inflows/outflows to displace an amount of the water to raise the static height of the water level to a desirable dynamic (operating) height and a depth of froth layer which is known to give adequate froth layer drainage characteristics.

In some embodiments, the method further comprises the step of removal of at least some of the froth layer from the upper portion of the chamber. This step may be done intermittently rather than on a continuous basis, for example in batch style operations.

In some embodiments, the secondary treatment step for treating the collapsed froth layer including the concentrated substance uses at least one of the processes of the group comprising: absorption (using activated carbon, clay, or ion exchange resins), filtration (using reverse osmosis membranes); vacuum distillation; drum drying; and introduction of further quantity of gas into a separate containment apparatus to produce another froth layer comprising a further concentrated amount of the substance, this latter step being essentially a repeat of the concentration step which took place in the chamber, in order to further reduce the volume of concentrate which needs to be transported from the treatment site, or otherwise treated.

In some embodiments, the substance is organic, and in one form the organic substance is at least one of a perfluoroalkyl substance or a polyfluoroalkyl substance (PFAS). More specifically, the perfluoroalkyl or polyfluoroalkyl substance (PFAS) includes one or more of the group comprising: perfluoro-octane sulfonate (PFOS); perfluoro-octanoic acid (PFOA); perfluoro-n-hexane sulfonic acid (PFHxS); perfluoro-nonanoic acid (PFNA); perfluoro-decanoic acid (PFDA/Ndfda); 6:2-fluorotelomer sulphonate compounds (6:2 FTS); 8:2-fluorotelomer sulphonate compounds (8:2 FTS); and perfluoro-octanoic acid (PFHpA); poly fluorinated carboxylic acids, alkyl sulfonates and alkyl sulfonamido compounds; and fluorotelemeric compounds, each having differing carbon chain lengths; and including precursors of these.

In a second aspect, there is provided an apparatus for separating an amount of a substance from water which is contaminated with the substance, the apparatus comprising: a chamber having an inlet which is arranged in use to admit thereinto an amount of the contaminated water which includes an initial concentration of the substance; a gas introduction device which in use admits gas into the chamber, the introduced gas for inducing water to flow within the chamber, and for producing a froth layer which is formed at, and which rises above an interface with the said flow of water and introduced gas in the chamber, the froth layer including an amount of water and also a concentrated amount of the substance when compared with its initial concentration; wherein the apparatus is arranged in use to contain the froth layer near an upper portion of the chamber and to control the water content of the froth layer which rises above the interface, to influence the concentration of the substance therein; and a device for removing at least some of the froth layer from the upper portion of the chamber.

In some embodiments a bubble generation device is located prior to or at the point when the flow of introduced gas enters the water located in the chamber.

In some embodiments, said gas introduction device comprises one or more gas inlet flow pipes which are arranged about a circumferential peripheral wall of the chamber and which extend into an interior of the chamber via a respective opening in said peripheral wall, in use for admitting gas into the chamber.

In some embodiments, the apparatus used for providing control of the water content of the froth layer comprises apparatus for at least one of: controlling a physical parameter of the flow of introduced gas; and controlling a physical parameter of the froth layer.

In some embodiments, the apparatus used for control of a physical parameter of the flow of introduced gas into the chamber comprises the use of a flow controller and an inlet valve on a gas delivery line, responsive to a measurement of one of the group comprising: water content of the froth layer; froth stability of the froth layer; location of the interface in the chamber.

In some embodiments, the froth depth regulation device is arranged for confining the cross-sectional flow path of the froth in the chamber, resulting in froth confinement and drainage of said froth layer. Apparatus which is shaped to confine or squeeze a rising froth layer can cause additional drainage of the froth layer, and may include changes to the cross-sectional open area of froth flow, for example by the use of froth crowders, narrow necked passages or channels or capillaries, tapered funnels, weir skimmers, for example.

In some embodiments, the apparatus further comprises a froth layer removal device in which at least some of the froth layer is collapsed during removal of at least some of the froth layer from the uppermost region of the chamber, and prior to a secondary treatment step.

In some embodiments, the apparatus further comprises a secondary treatment device in use for treating the collapsed froth layer for removal of the concentrated substance, wherein the treatment device includes at least one of the group comprising: absorption (using activated carbon, clay, or ion exchange resins), filtration (using reverse osmosis membranes); vacuum distillation; drum drying; and introduction of further quantity of gas into a separate containment apparatus to produce another froth layer comprising a further concentrated amount of the substance, this latter step being essentially a repeat of the concentration step which took place in the first stage separation chamber(s), for the advantages previously recited in relation to the method of use of the apparatus.

In one embodiment, the apparatus used to control the water content of the froth layer is arranged at a fixed location within the chamber, and the location of the interface is adjustable responsive to the flow of the introduced gas, so that the froth depth can be stably positioned relative to the apparatus. In one particular embodiment, the apparatus used to control the water content of the froth layer comprises a flow controller and an inlet valve on a gas delivery line for controlling the flow of the introduced gas. In another particular embodiment, the apparatus used to control the water content of the froth layer further comprises a bubble generation device located prior to or at the point when the flow of introduced gas in the gas delivery line enters the water located in the chamber.

In some embodiments, the apparatus used to control the water content of the froth layer can comprise further devices for controlling a physical parameter of the froth layer. In one form of this, the said device controls the cross-sectional flow path of the froth in the chamber, resulting in froth confinement and drainage. Apparatus which is shaped to confine or squeeze a rising froth layer can cause additional drainage of the froth layer, and may include changes to the cross-sectional open area of froth flow, for example by the use of froth crowders, narrow necked passages or channels or capillaries, tapered funnels, weir skimmers, for example.

In a third aspect, there is provided a method of separating an amount of a substance from water which is contaminated with the substance, the method comprising the steps of: admitting said contaminated water into a chamber via an inlet thereinto; introducing a flow of gas into a lowermost region of the chamber, wherein the introduced gas induces an upward flow of water in the chamber, and produces a froth layer which rises above an interface with the water in an upper portion of the chamber, the froth layer including a concentrated amount of the substance when compared with its concentration in the contaminated water first admitted to the chamber; collecting a sufficient amount of said froth layer and, after allowing it to collapse back into a liquid form, passing said liquid to a second chamber via an inlet thereinto; introducing a flow of gas into a lowermost region of the second chamber, wherein the introduced gas induces an upward flow of water in said chamber, and produces a froth layer which rises above an interface with the water in an upper portion of the second chamber, the froth layer including a further concentrated amount of the substance; and in said second chamber, regulating at least one of (i) depth of the froth layer above the interface using a froth layer depth regulation system, and (ii) depth of water in the chamber, said regulation being responsive to movement of the location of the interface; such that the water content of the froth layer near the uppermost region of the second chamber is controlled, to influence the concentration of the substance therein.

In some embodiments, for at least one of the first or the second chambers, the upward flow of gas and the production of the froth layer occurs in a batchwise operational manner.

In some embodiments, the step of controlling the water content of the froth layer in the upper region of a chamber is by at least one of the group comprising: controlling a physical parameter of the flow of introduced gas; and controlling a physical parameter of the froth layer.

In some embodiments, the step of controlling the depth of water in a chamber is by at least one of the group comprising: controlling a physical parameter of the flow of introduced gas; and controlling an inlet flow of additional water.

In some embodiments, the steps of the method of the third aspect are otherwise as defined for the first aspect.

In some embodiments of the method, the secondary treatment step for treating the collapsed froth layer, including the concentrated substance, uses at least one of the processes of the group comprising: absorption (using activated carbon, clay, or ion exchange resins), filtration (using reverse osmosis membranes); and introduction of further quantity of gas into a separate containment apparatus to produce another froth layer comprising a further concentrated amount of the substance.

Other aspects, features, and advantages will become further apparent from the following detailed description when read in conjunction with the accompanying drawings which form a part of this disclosure and which illustrate, by way of example, principles of the inventions disclosed.

### DESCRIPTION OF THE FIGURES

The accompanying drawings facilitate an understanding of embodiments of the apparatus, system and method of the disclosure. To simplify the nomenclature and to facilitate better understanding of each embodiment, is noted that in each Figure, like functional parts to those functional parts which are shown in the drawings of other embodiments have been given like part numbers. However, the different embodiments are differentiated by a letter of the alphabet following that like part number, for example froth flotation cells 10, 10A, 10B, 10C.

FIG. 1 shows a schematic, top, perspective view of a froth flotation (or foam fractionation) apparatus for separating an amount of a substance from water which is contaminated with the substance, the apparatus including a conical flotation chamber and a second chamber arranged to facilitate froth drainage, in accordance with one embodiment of the present disclosure;

FIG. 2 shows a top, plan view of the apparatus of FIG. 1;

FIG. 3 shows a schematic, side elevation view of the apparatus of FIG. 1;

FIG. 4 shows a schematic top perspective view of the conical flotation chamber and the second chamber arranged to facilitate froth drainage, in the froth flotation apparatus of FIG. 1;

FIG. 5 shows a top, plan view of the apparatus of FIG. 4 indicating the vertical sectional planes F-F and D-D;

FIG. 6 shows a schematic, sectional side elevation view of the apparatus of FIGS. 4 and 5, when viewed in the directional of the vertical sectional plane F-F;

FIG. 7 shows a schematic, sectional side elevation view of the apparatus of FIGS. 4 and 5, when viewed in the directional of the vertical sectional plane D-D;

FIG. 8 shows a schematic, detailed sectional side elevation view of the apparatus of FIG. 7, being a detailed view of the portion which is shown in the ring E;

FIG. 9 shows a schematic, sectional, side elevation view of a conical flotation chamber and a second chamber arranged to facilitate froth drainage, each forming part of an apparatus for separating an amount of a substance from water which is contaminated with the substance, in accordance with another embodiment of the present disclosure;

FIG. 10 shows a schematic, underside, perspective view of a base of a froth flotation chamber as well as a drainage conduit extending therebelow, each forming part of an apparatus for separating an amount of a substance from water which is contaminated with the substance, in accordance with another embodiment of the present disclosure;

FIG. 11 shows a schematic, top, perspective view of a froth flotation (or foam fractionation) apparatus for separating an amount of a substance from water which is contaminated with the substance, the apparatus including a conical flotation chamber and a second chamber arranged to facilitate froth drainage, in accordance with another embodiment of the present disclosure;

FIG. 12 shows a top, plan view of the apparatus of FIG. 11;

FIG. 13 shows a schematic, side elevation view of the apparatus of FIG. 11;

FIG. 14 shows a schematic top perspective view of the conical flotation chamber and the second chamber arranged to facilitate froth drainage, in the froth flotation apparatus of FIG. 11;

FIG. 15 shows a top, plan view of the apparatus of FIG. 14 indicating the vertical sectional planes K-K and M-M;

FIG. 16 shows a schematic, side elevation view of the apparatus of FIGS. 14 and 15, indicating the horizontal sectional planes N-N, O-O and P-P;

FIG. 17 shows a schematic, sectional side elevation view of the apparatus of FIGS. 14 and 15, when viewed in the directional of the vertical sectional plane K-K;

FIG. 18 shows a schematic, detailed sectional side elevation view of the apparatus of FIG. 17, being a detailed view of the portion which is shown in the ring L;

FIG. 19 shows a schematic, sectional side elevation view of the apparatus of FIGS. 14 and 15, when viewed in the directional of the vertical sectional plane M-M;

FIG. 20 shows a schematic, side elevation view of the apparatus of FIG. 14;

FIG. 21 shows a schematic, top plan view of the apparatus of FIGS. 14 and 16, when viewed in the directional of the horizontal sectional plane P-P;

FIG. 22 shows a schematic, top plan view of the apparatus of FIGS. 14 and 16, when viewed in the directional of the horizontal sectional plane N-N; and

FIG. 23 shows a schematic, top plan view of the apparatus of FIGS. 14 and 16, when viewed in the directional of the horizontal sectional plane O-O.

FIG. 24 shows a schematic, top, perspective view of a froth flotation (or foam fractionation) apparatus for separating an amount of a substance from water which is contaminated with the substance, the apparatus including a conical flotation chamber and a second chamber arranged to facilitate froth drainage, in accordance with another embodiment of the present disclosure;

FIG. 25 shows a schematic top perspective view of the conical flotation chamber and the second chamber arranged to facilitate froth drainage, in the froth flotation apparatus of FIG. 24;

FIG. 26 shows a top, plan view of the apparatus of FIG. 25 indicating the vertical sectional planes K-K and M-M;

FIG. 27 shows a schematic, side elevation view of the apparatus of FIGS. 25 and 26, indicating the horizontal sectional planes N-N, O-O and P-P;

FIG. 28 shows a schematic, sectional side elevation view of the apparatus of FIGS. 25 and 26, when viewed in the directional of the vertical sectional plane K-K;

FIG. 29 shows a schematic, detailed sectional side elevation view of the apparatus of FIG. 28, being a detailed view of the portion which is shown in the ring L;

FIG. 30 shows a schematic, sectional side elevation view of the apparatus of FIGS. 25 and 26, when viewed in the directional of the vertical sectional plane M-M;

FIG. 31A shows a schematic, side elevation view of the apparatus of FIG. 25;

FIG. 32A shows a schematic, top plan view of the apparatus of FIGS. 25 and 27, when viewed in the directional of the horizontal sectional plane P-P;

FIG. 33A shows a schematic, top plan view of the apparatus of FIGS. 25 and 27, when viewed in the directional of the horizontal sectional plane N-N; and

FIG. 34A shows a schematic, top plan view of the apparatus of FIGS. 25 and 27, when viewed in the directional of the horizontal sectional plane O-O.

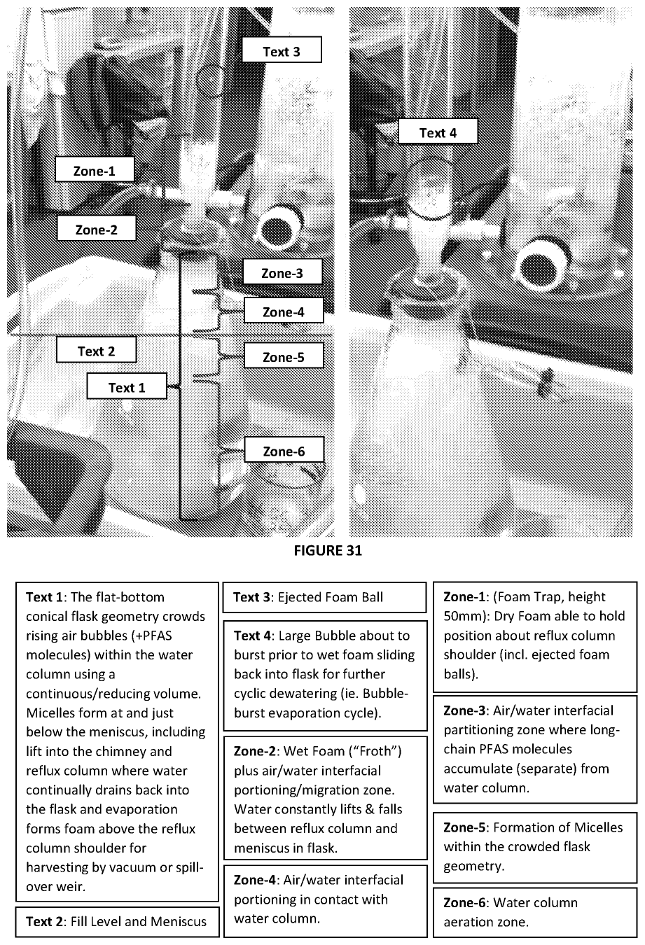

FIG. 31 shows photographs of a flat bottom conical flask fitted with an uppermost vertical reflux column experimental model test unit, to demonstrate the principles of the conical-shape flotation cell, in accordance with another embodiment of the present disclosure;

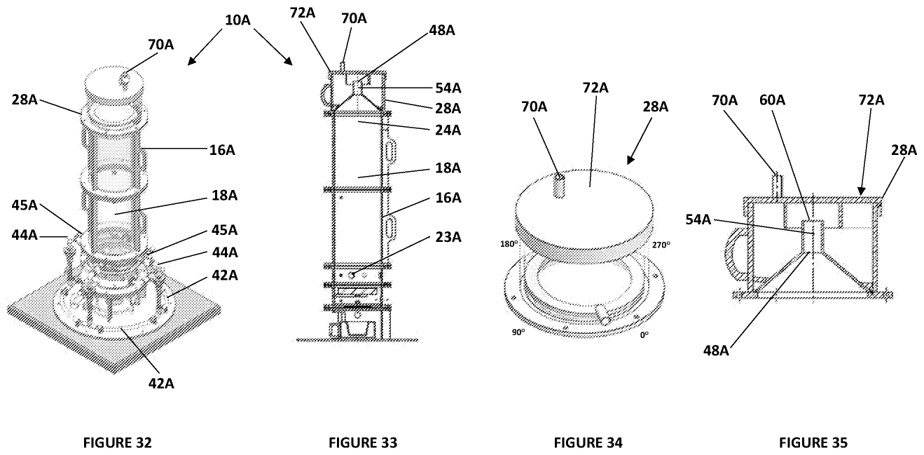

FIG. 32 shows a schematic, top, perspective view of a froth flotation (or foam fractionation) apparatus for separating an amount of a substance from water which is contaminated with the substance, the apparatus including a conventional, cylindrically-shaped column flotation chamber and a second chamber located above that, arranged to capture the concentrate and to facilitate froth drainage, in accordance with the prior art;

FIG. 33 shows a schematic, sectional side elevation view of the apparatus of FIG. 32;

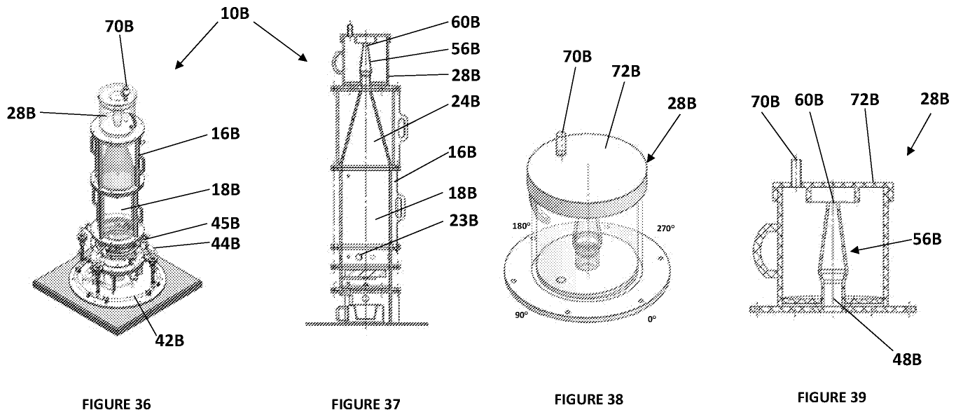

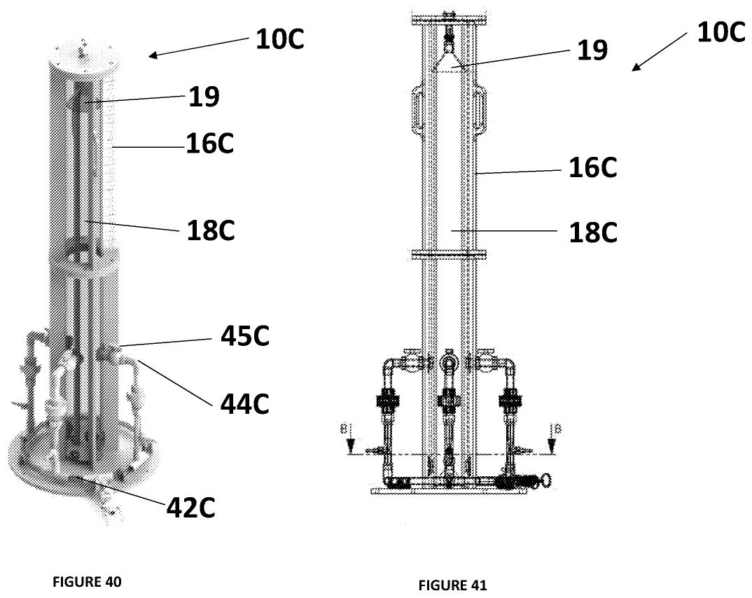

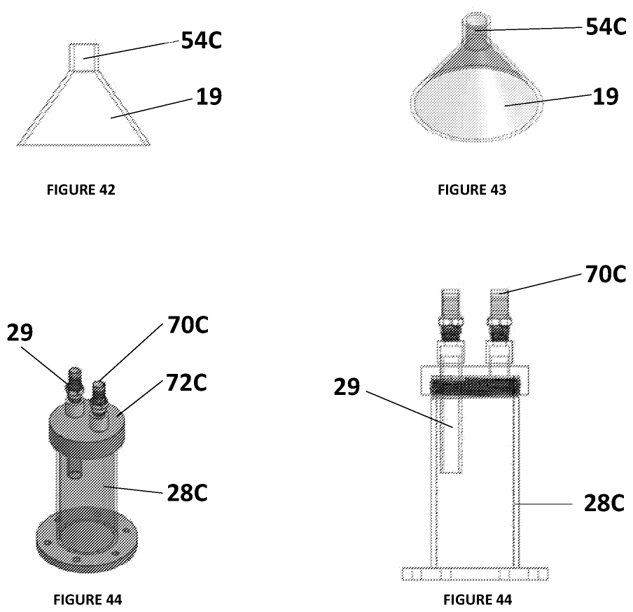

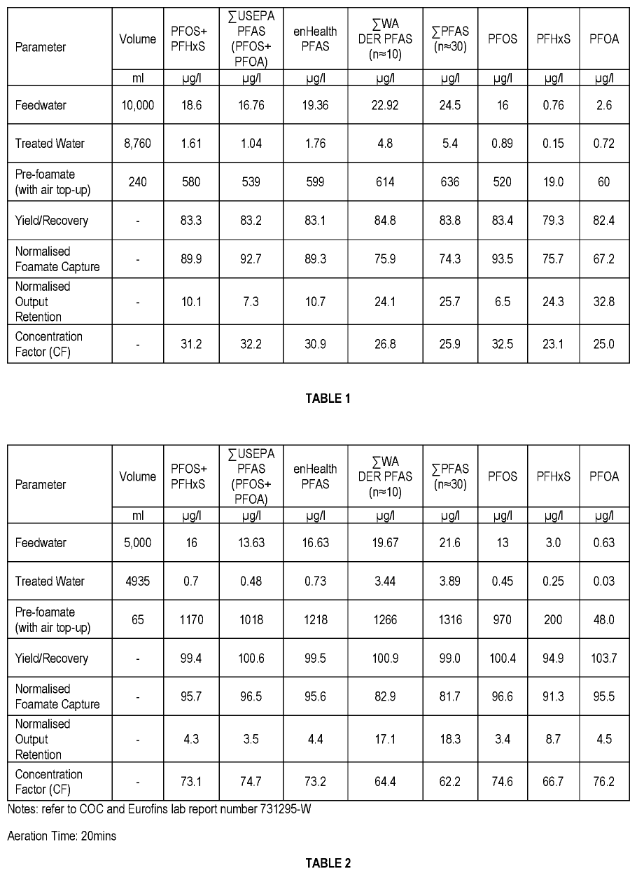

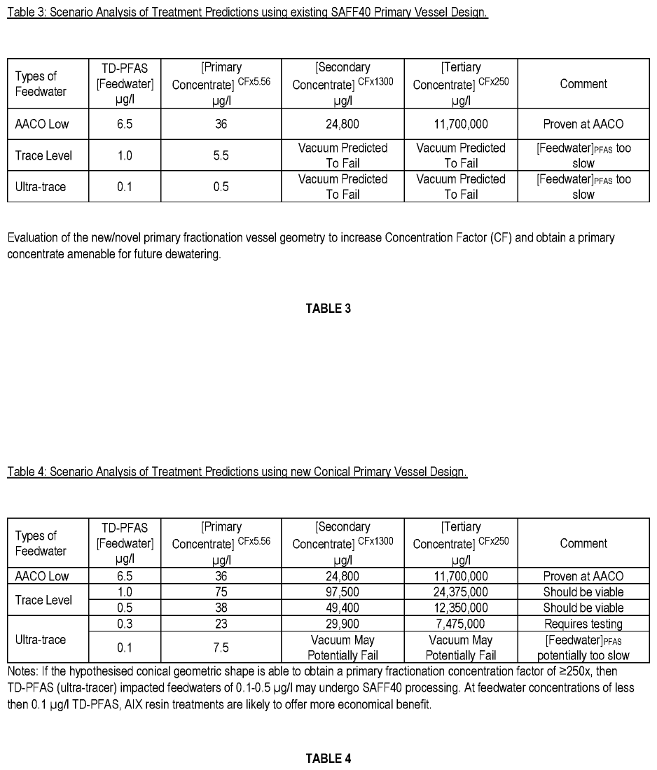

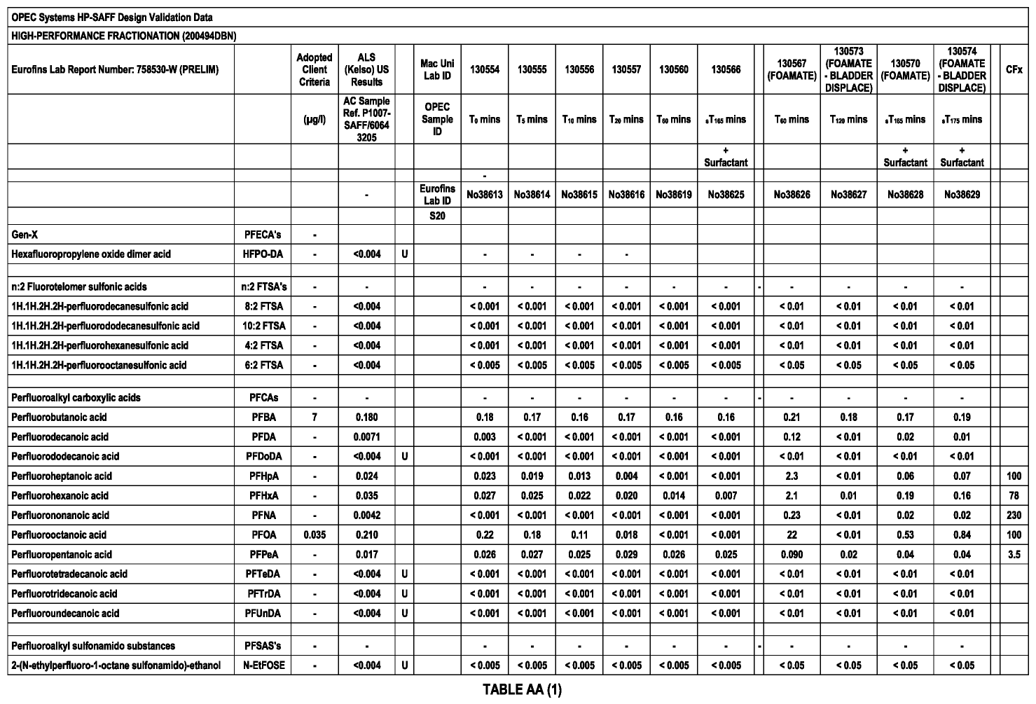

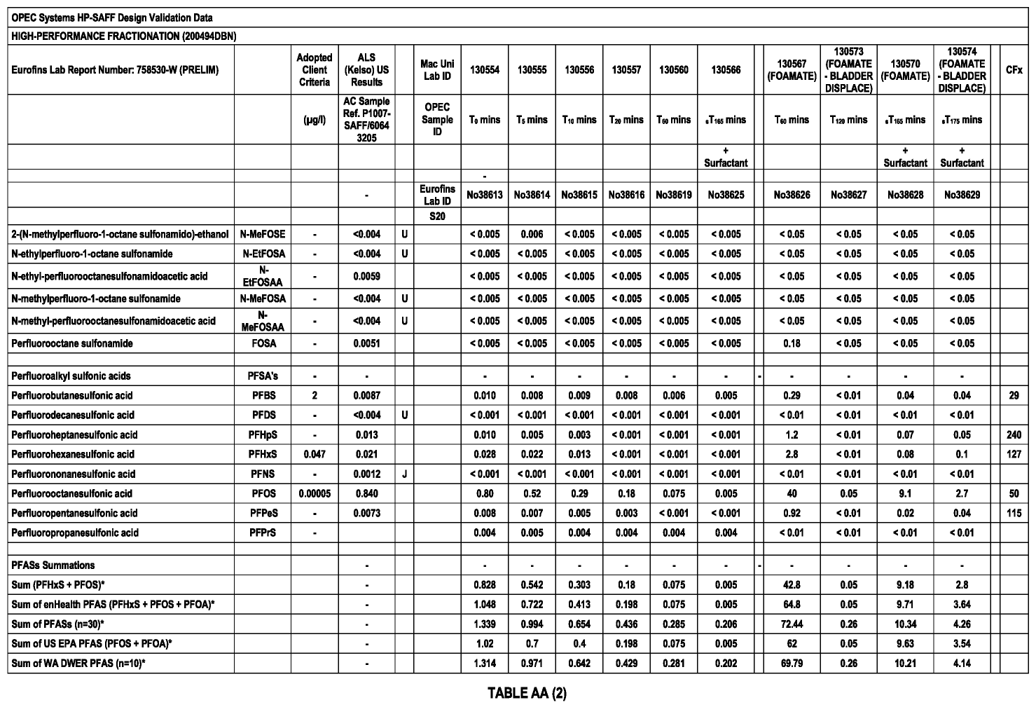

FIG. 34 shows a schematic, top, perspective view of a froth flotation (or foam fractionation) apparatus, the apparatus comprising a conventional, cylindrically-shaped second chamber which is located in use above the column flotation chamber and is arranged to capture and drain the froth concentrate, in accordance with the prior art;

FIG. 35 shows a schematic, sectional side elevation view of the apparatus of FIG. 34;

FIG. 36 shows a schematic, top, perspective view of a froth flotation (or foam fractionation) apparatus for separating an amount of a substance from water which is contaminated with the substance, the apparatus including a partially cylindrical and a partially conical flotation chamber, and a second chamber arranged to facilitate froth drainage, in accordance with another embodiment of the present disclosure;

FIG. 37 shows a schematic, sectional side elevation view of the apparatus of FIG. 36;

FIG. 38 shows a schematic, top, perspective view of a froth flotation (or foam fractionation) apparatus, the apparatus comprising a conventional, cylindrically-shaped second chamber which is located in use above the conical and column flotation chamber and is arranged to capture and drain the froth concentrate exiting the second chamber, in accordance with another embodiment of the present disclosure;

FIG. 39 shows a schematic, sectional side elevation view of the apparatus of FIG. 34;

FIG. 40 shows a schematic, top, perspective view of a froth flotation (or foam fractionation) apparatus for separating an amount of a substance from water which is contaminated with the substance, the apparatus including a conventional, cylindrically-shaped column flotation chamber and a suction hood, arranged to capture the concentrate and to facilitate froth drainage, in accordance with the prior art;

FIG. 41 shows a schematic, sectional side elevation view of the apparatus of FIG. 40;

FIG. 42 shows a schematic, sectional side elevation view of the apparatus of FIG. 43;

FIG. 43 shows a schematic, underside, perspective view of view of a suction hood, arranged to capture the concentrate and to facilitate froth drainage, in accordance with the prior art;

FIG. 42 shows a schematic, top, perspective view of a froth flotation (or foam fractionation) apparatus, the apparatus comprising a conventional, cylindrically-shaped second chamber which is located in use above the column flotation chamber and is arranged to capture and drain the froth concentrate, in accordance with the prior art;

FIG. 43 shows a schematic, sectional side elevation view of the apparatus of FIG. 42;

FIG. 44 shows a schematic, top, perspective view of a froth flotation (or foam fractionation) second chamber, arranged to capture the concentrate from a column flotation chamber and to facilitate froth drainage, in accordance with the prior art;

FIG. 45 shows a schematic, sectional side elevation view of the apparatus of FIG. 44.

### DETAILED DESCRIPTION

This disclosure relates to the features of a froth flotation cell 10, 10A, 10B, 10C, and its method of use, for removal of an organic contaminant from a body of water which is placed into that flotation cell for treatment. Typically, such contaminated water is obtained by extraction pumping from a nearby aquifer or groundwater well, or from some other water storage containment.

Water which is suitable for treatment by the apparatus and methods disclosed in this specification can have a very low, or even trace, level of organic contaminants which are dissolved or dispersed therein, and of particular interest are amphiphilic molecular compounds. Amphiphilic substances consist of molecules having a polar water-soluble group attached to a water-insoluble hydrocarbon chain, for example common surfactants (such as sodium dodecyl sulfate (SDS) an anionic surfactant, and cetyl-trimethyl-ammonium bromide (CTAB)), soaps, detergents, and lipoproteins. Amphiphilic substances can also include hazardous contaminants such as as perfluoroalkyl substances or polyfluoroalkyl substances (PFAS).

As a result of having both lipophilic and hydrophilic portions, many amphiphilic compounds dissolve in water to some extent. The extent of the hydrophobic and hydrophilic portions determines the extent of partitioning. Soap is a common household amphiphilic surfactant compound. Soap mixed with water (polar, hydrophilic) is useful for cleaning oils and fats (non-polar, lipiphillic) from kitchenware, dishes, skin, clothing, and so on. When exposed to fluid mixing and the addition of gas bubbles such as air, the longer the carbon chain, the more likely it is that amphiphilic compounds preferentially come out of a water solution, and attached to a rising air bubble, forming a froth which will likely carry the hydrophobic material with it.

When the term “froth flotation” is used in the present specification, it may be interchangeably used with the terms “foam fractionation”, and “bubble fractionation”, since the apparatus and method that are employed in each instance are essentially the same, when operating in a two-phase mixture (that is, a mixture of a liquid and a gas). This is because the present process operates best when just a small amount of suspended solids is present in the water, giving a relatively low turbidity.

In an example which is presented in this specification, a stable wet foam can be produced by a froth flotation (or a foam fractionation) apparatus, in which water, which is contaminated with a sufficient (above minimum) concentration of an amphiphilic compound, is agitated, and air bubbles are introduced into, or produced by some means in, the contaminated water. The result is a stable wet foam which rises above the air/water interface at the upper surface level of the air/water mixture, and which carries most of the amphiphilic compounds out of solution. When the foam collapses, the flotation process yields a small volume of concentrated amphiphilic compounds in solution, when compared to the initial concentration in the contaminated water.

In a further example of using the froth flotation apparatus and method which is presented in this specification, the agitation and aeration of water in which only very low or trace levels of amphiphilic compounds are present, will likely be a very weak foam. The present inventors have shown that in such situations, an unstable foam which forms at the upper surface of the contaminated water in the flotation cell can benefit from a new design of conical-shaped foam fractionation cell, which can assist the foam itself to become more stable and thus be recovered, and to thereby remove the trace amphiphilic compounds from the water.

In a further example of using the froth flotation apparatus and method which is presented in this specification, the agitation of contaminated water in which very low or trace levels of amphiphilic compounds are present, along with the introduction of air bubbles, may give no yield of foam at all. However, the inventors have shown that the amphiphilic compounds which are present will still experience some partitioning in the water. The term given to this sort of separation is “bubble fractionation”, being a partial separation of components within a solution, which results from the selective adsorption of such compounds at the surfaces of rising air bubbles. Typically, in a batchwise operation, the present inventors have shown that as gas bubbles rise up though the solution, the adsorbed solute is also carried upward, and if it is non-volatile (such as PFAS), the solute is then deposited in the top region of the liquid as the gas bubbles burst, and the gas exits. After a time, a steady-state enrichment of the amphiphilic compounds occurs in the upper region of the fluid in the flotation cell. At this point, if an upward, volumetric displacement of some of the fluid within the flotation cell is arranged, the net effect will be to push/discharge/overflow that uppermost enriched solution of adsorbed solute out of the top of the flotation cell, to thereby remove the trace amphiphilic compounds from the water.

A further example of using the froth flotation apparatus and method which is presented in this specification can be applied to improve either of the previous two water treatment examples, for a ‘weak froth’ (use the new flotation cell design) or a ‘no froth’ (bubble fractionation) situation. During the agitation of water in the froth flotation apparatus, in which very low or trace levels of contaminant amphiphilic compounds are present, and air bubbles are introduced, the inventors discovered that by introducing an additional, harmless amphiphilic compound (for example a surfactant, especially one with a long hydrocarbon chain) it can produce a very stable wet foam which rises above the air/water interface at the upper surface level of the air/water mixture, and that wet foam will carry the contaminant amphiphilic compounds out of the solution with it. When the foam collapses, this “assisted” bubble fractionation process yields a small volume of more concentrated amphiphilic contaminant when compared to its initial concentration in the contaminated water, as well as also recovering almost all of the amphiphilic surfactant compound which was added.

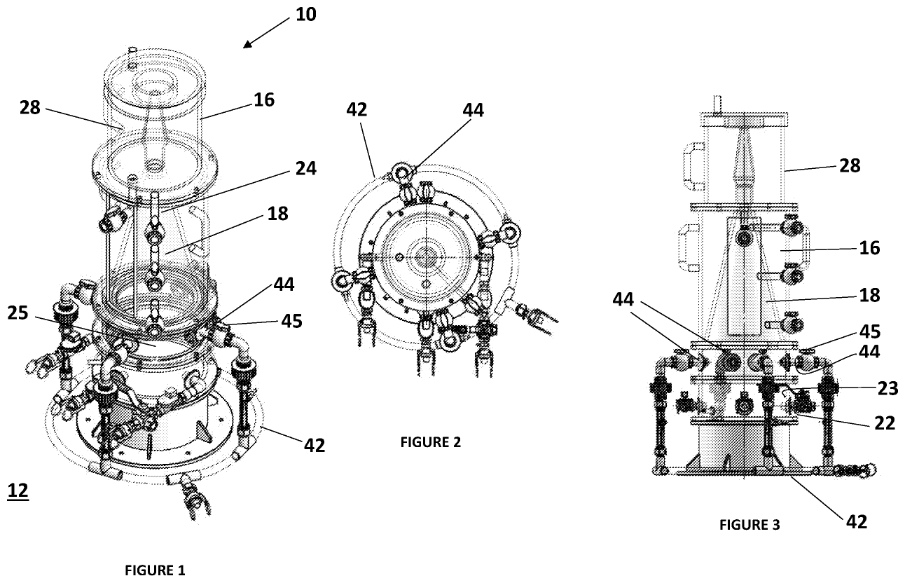

Referring now to the Figures, and to the embodiment shown in FIG. 1, the flotation cell 10 is in the form of an elongate, cylindrical column 16 having an interior chamber 18. The column 16 is circular in cross-section, and is positioned to stand vertically upright on surrounding ground 12. The column 16 can be a tube or a plurality of casing elements 14 made of hard plastic or metal, and be sufficiently strong to provide impact protection for the structure of the interior chamber 18 of the column 16, as well as being a mounting point for external equipment such as depth gauges, air manifold pipes and other instrumentation.

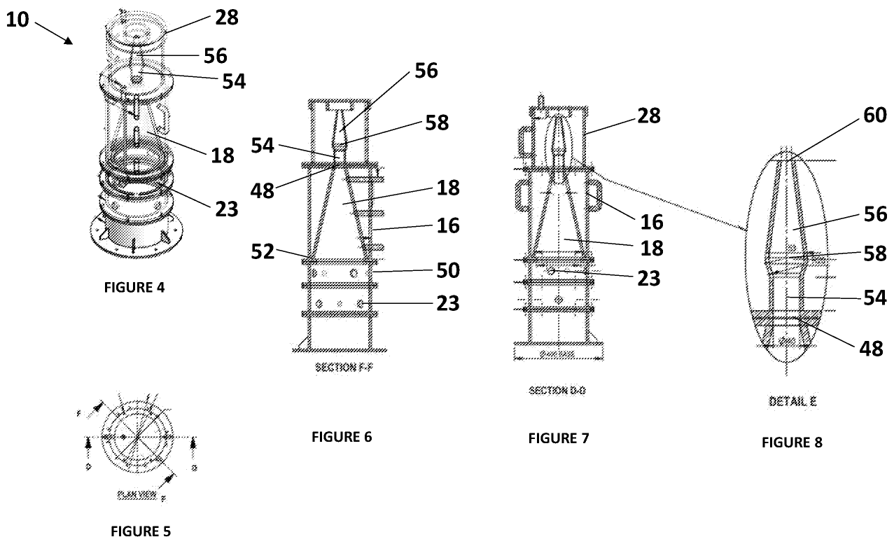

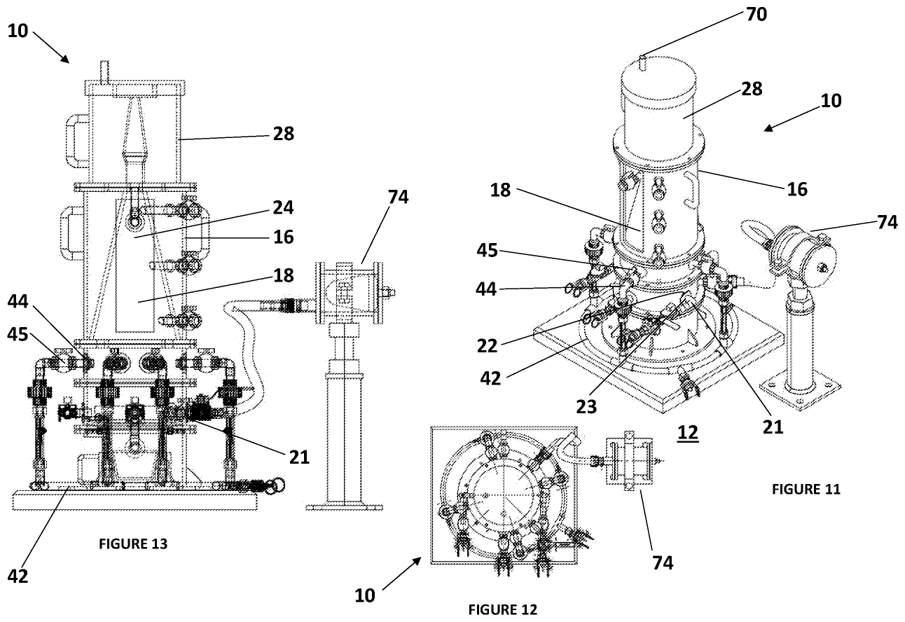

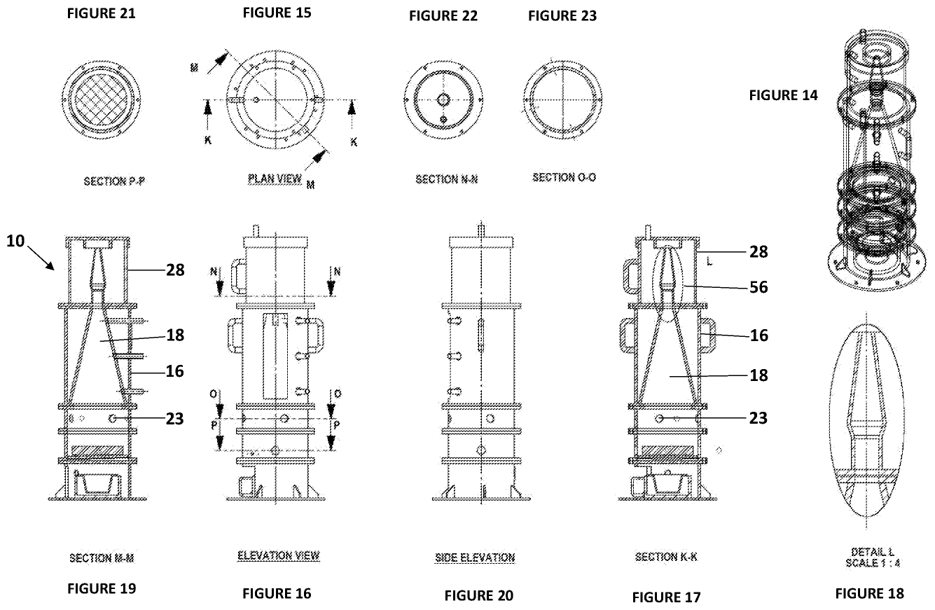

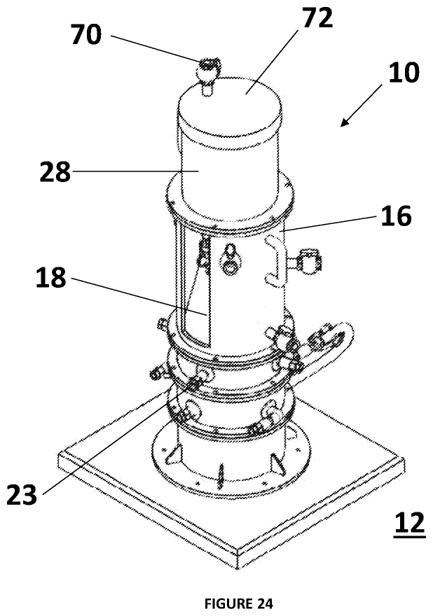

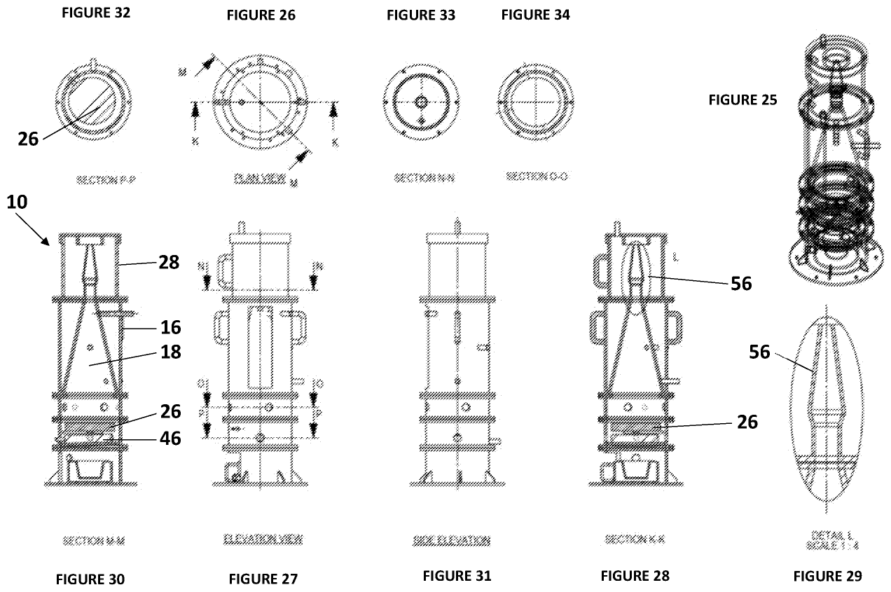

The interior chamber 18 has an inlet which is arranged to admit water feed material thereinto, located nearer the lowermost in use end 25 of the flotation cell 10. In the embodiment shown in FIGS. 1 to 8, and also in the embodiments shown in FIGS. 11 to 23, and FIGS. 24 to 34, the inlet is in the form of a series of circumferential holes 22, arranged to extend through the outer casing wall of the column 16, and a respective aligned hole 23 in the casing wall of the interior chamber 18. Into each pair of those aligned, circumferential holes 22, 23, a respective conduit 21 can be positioned in use, so that it is oriented orthogonally to the elongate axis of the column 16. In use, the or each conduit(s) 21 convey(s) a flow of liquid which is pumped therethrough from a source, such as a groundwater holding tank or other type of holding reservoir, into the chamber 18. This fluid filling stage can be done on a continuous or an intermittent basis, depending on whether the flotation cell 10 is being operated in a continuous flow or batch mode.

During use, gas is charged into the chamber 18 at a pressure and flow rate to allow bubbles to form and then, due to buoyancy, rise upward along the length of the chamber 18. Typically, the gas used is compressed air, but other gases can be used depending on the site requirements. For example, to oxygenate the water, the gas introduced could be oxygen and/or ozone, perhaps mixed with air. The selected gas is typically caused to flow by means of a pump or some other source of compressed or pressurised gas which is located nearby (for example, the air pump 74 shown in FIGS. 11 to 13), and which is connected via a conduit (such as a pipe or a hose) which provides entry of the gas into the chamber 18. Several options for how to introduce the gas for froth flotation are presented in the forthcoming description.

The dispersion of the flow of air being injected into the chamber 18 as it swirls around can be sufficient to cause the dispersion of the air and formation of air bubbles in the water in the chamber 18. In other ways to introduce a gas, a bubble generation device may be fitted onto a pipe through which a portion of the water in the chamber 18 is recirculated by pumping. The bubble generation device may be some sort of in-line gas induction device, such as a venturi restrictor, into which gas is either drawn into the moving liquid flow by induction, or pumped into the liquid via the venturi restrictor. In either case, the flow passage is immediately expanded, thereby causing bubbles to be formed. The gas introduction device can also be in the form of a sparger or bubbler (typically made of a sintered metal or from a ceramic material) for example as shown in FIGS. 28 and 30 in the form of an air diffuser disc 26 which is located in the chamber 18 near its lowermost in use end 25, and positioned to discourage settling of particulate material in that end of the chamber 18, and to ensure that there are no locations of the chamber 18 where circulation of air and water is not occurring.

FIGS. 1, 2 and 3 and also FIGS. 11, 12 and 13 show further embodiments of an air inlet system for the foam fractionation chamber 18. Air inlet pipes 44 are located at various orifices in the vessel walls, those inlet pipes 44 connected to an externally-placed, ring-shaped pipe manifold 42 which extends at least partially around the outer circumference of the flotation column 16, and arranged in use to distributes air around each of the inlet pipes 44 and then via the nozzles (for example, venturi nozzles) which extend into the chamber 18 near its lowermost in use end 25. The venturi restrictors can be starved or even deactivated by means of a butterfly valve connector 45 arranged on each inlet pipe 44.

In an alternative arrangement for aeration of the flotation vessels described in this specification, a submersible aeration apparatus can be located inside the flotation chamber, and seated at or near the base region of that chamber. For example, a 2.2 kW air pump can deliver air into the flotation vessel, and disperse that air via an outlet from the pump featuring a rotor and stator combination, to produce small bubbles which then can rise upward from the base region of the chamber 18. The typical air inlet rate can be approximately 40-80 m3/h of air injected into a 2,500 L litre liquid chamber having a depth of 2-3 metres.

Typically, one submersible pump can be installed on the interior bottom surface of the flotation tank, and the pump may have inbuilt venturi and applicator nozzles in the base. The goal of such an alternative configuration is a similar aeration level of the vessel contents achieved in use, but of considerably cheaper capital cost when compared to the need for 5-10 air inlet pipes fitted into the walls of the chamber 18, each with venturi nozzles.

Whichever way it is achieved, once the gas bubbles are formed they will rise under their own buoyancy in the chamber 18, and be mixed with the water which has flowed into the chamber 18 via the conduit 21, and fill the chamber 18. The bubbles will rise toward the uppermost end 24 of the chamber 18 within the column 16, and during this residence time have had plenty of opportunities to interact with the water, and for the bubbles to come into contact with even trace or dilute quantities of organic contaminant(s) present in that water.

At the uppermost end 24 of the chamber 18, the interaction of the bubbles and the organic contaminant in the water may result in the formation of a froth layer 32, which develops immediately above an interface located at the raised dynamic water level 37 (DWL, or H) of water which is located within the chamber 18. The static water level 34 (or Hs) rises to the dynamic water level 37 (or H) once the flow of air is added during such a foam fractionation, or froth flotation, treatment process. The DWL 37 can be controlled by various means, including by the design of the chamber and outlet, however the primary control is undertaken by variations in the inlet gas delivery rate, the water inflow and outflow rates, or in some controlled combination of gas delivery and water flow, as will shortly be described.

In one example, the inlet gas delivery rate can be regulated using information from a water level sensor which is located within the chamber 18 to detect the position of the interface at the DWL, where signals from such a level sensor can be sent to a control system connected to an adjustable valve on the gas delivery line. In another embodiment, the control system can be connected to a water inflow valve to allow more water into the chamber 18. In another embodiment, the control system can be connected to a fluid inlet and an outlet of an expandable bladder 46 located within the chamber 18, as will shortly be described. In each case, the control is intended to maximise the chance of a froth layer 32 which is formed being able to rise up and to exit the upper portion of the chamber 18 via the outlet opening, for example in a batch treatment process, by continuously maintaining or even raising the DWL 37 as the quantity of contaminant material in the water in the chamber 18 becomes depleted and is removed, along with a small amount of water, in a wet froth exiting an upper outlet opening 48 of the chamber 18.

In a further example of how to optimise the operation of the system, the inlet gas delivery rate into the chamber 18 can be regulated using information from a conductivity meter, or a water level sensor, which can be located on an interior wall of the chamber 18. Signals from the water level sensor can provide information about the water content of the froth layer 32, and can be sent to a control system connected to an adjustable valve on the gas delivery line. In such an example, if the froth layer 32 is insufficiently dry, the flow of introduced gas into the chamber may need to be decreased, because there is too much water being moved in the froth layer 32 and the process is not concentrating the contaminant sufficiently. Conversely if there is little or no production of froth, the flow of introduced gas into the chamber 18 may need to be increased.

In FIG. 3, the chamber outlet is also arranged to allow water which has been treated by froth flotation to remove contaminants, to egress the chamber 18 from a region nearer toward the lowermost in use end region, or base 25, of the flotation cell 10. In some embodiments shown in the Figures, the outlet from the chamber 18 is via the same circumferential holes 22 arranged to extend through the outer casing wall of the column 16, and a respective aligned hole 23 in the casing wall of the interior chamber 18 with a conduit 21 positioned in use through the aligned holes 22, 23. In use, the or each conduit(s) 21 can convey a flow of treated liquid by extraction pumping or by gravity drainage into a further holding tank or other channel to be recycled, for example by being returned to the ground, or pumped into a river or stream.

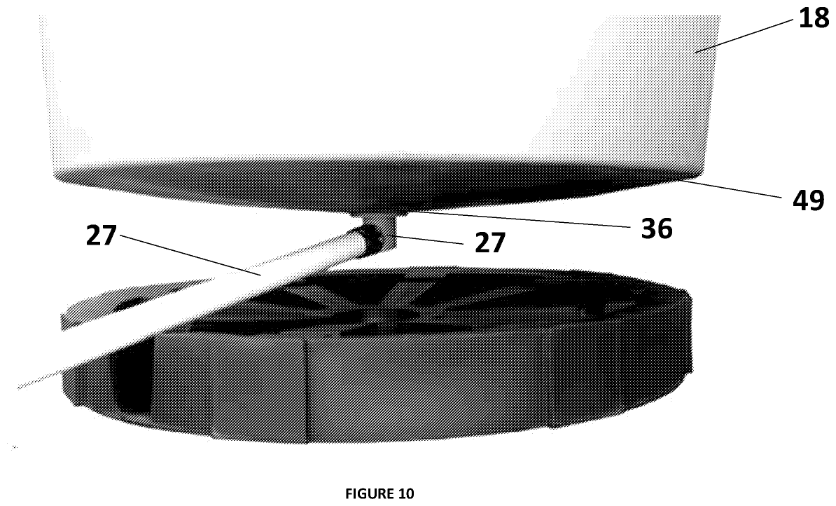

In a further embodiment shown in FIG. 10, the outlet from the chamber 18 is via a hole 36, arranged in a base wall of the chamber 18. The base wall is shown in the form of a circular dish 49 which is arranged to slope towards a central, lowermost point from which a conduit 27 depends downwardly in use. The central, lowermost point is where a part of the conduit 27 is aligned with the elongate axis of the column 16 and is arranged to to be able to drain out any remnant sludge/sediment from the chamber 18 along with the flow of treated liquid, at the conclusion of the foam fractionation operation. In use, the conduit 27 can convey a flow of treated liquid by extractive pumping, or by gravity drainage, into a further holding tank or other channel to be recycled, for example by being returned to the ground, or pumped into a river or stream.

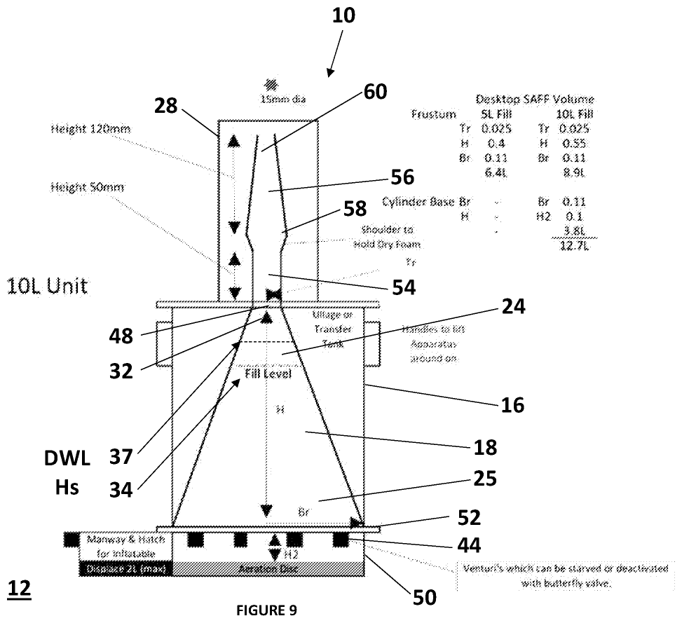

Referring to FIG. 9, the froth layer 32 formed above interface with the dynamic water level 37 in the chamber 18 will rise up inside the column 16 and further into the uppermost end 24 thereof. The wettest portion of the froth layer 32 is closest to the interface which forms at the upper surface of the dynamic water level 37 of water in the chamber 18, and it progressively drains and becomes drier as the froth layer 32 rises further above the interface within the column 16. Surface active material carried into the froth layer 32 includes the organic contaminant. In this way, the contaminant becomes much more concentrated in the froth layer 32 compared with its initial concentration in the feed water. The froth phase is also of considerably less volume to deal with for secondary processing, compared with the volume of feed water.

The geometric shape of the primary foam fractionation chamber 18, and the shape and configuration of the dry foam exit chamber or conduit, which is connected to, and located above that foam fractionation vessel, have been studied by the present inventors.

Referring to the drawings, a foam fractionation vessel is shown with a primary foam fractionation chamber 18 which is at least partially conical in its internal geometric shape, for example in FIGS. 9, 19 and 30. The upper portion of the chamber 18 is conically shaped—that is, the diameter of the foam fractionation column has a progressively smaller, circular, internal cross-sectional shape when moving upwardly over its vertical height, extending between an upper edge 52 of a circular circumferential side wall 50 and a region just below an uppermost edge 48 of the chamber 18, being the stem or neck 54 of the conical chamber 18. The circular circumferential side wall 50 is located in a close facing relationship with the cylindrical wall of the column 16.

In use, it was observed that the rising air bubbles will crowd into the column neck after the commencement of aeration of the conical-shaped foam fractionation chamber 18, as the rising foam volume is confined into an ever-smaller cross-sectional area. The rising foam or froth can eventually reach the region just below the uppermost edge 48 of the chamber 18. This gradual confinement appears to assist even a weak foam to become thicker and then, as a result, be stable enough to bridge the width of the neck 54, and to more effectively rise upward for harvesting and physical removal from the chamber 18.

This result was achieved by ensuring that the DWL 37, above which the froth layer 32 is formed, is located in the uppermost in use end 24 of the conical-shaped portion of the foam fractionation chamber 18. The inventors observed that initiation of enhanced crowding of rising air bubbles within the water column helped to obtain a PFAS-rich froth, which was sufficiently thick and strong enough to transform into a wet foam which rose upwardly above the air-water interface (or meniscus).

Further experiments were aimed at testing the effectiveness of continual aeration of the froth or wet foam during its rise upward out of the conical-shaped chamber 18. The inventors developed an exit chamber or conduit 56 of an extended length (height) in the form of a condensation or reflux column, which was located above the foam fractionation chamber 18 and arranged to receive the wet froth exiting the chamber 18 via the upper outlet opening 48 of the chamber 18.

The inventors formed the view that the upward flow of gas into the exit chamber can cause enhanced collapse of the wet froth by the drainage of the interlamellar film, as well as the evaporation displacement of water, resulting in an increased rate of bursting of the froth air bubbles. Such further dewatering of the wet foam was found to produce a more desirable thicker, drier foam. This type of foam is then more easily harvested in a flow of concentrate which either spills over a weir/launder, or via a vacuum suction foam extraction method, to further increase the PFAS concentration factor in the removed foamate.

The internal shape of an in use lower region of the exit chamber 56 featured a shelf or shoulder region 58 where the internal bore diameter of the chamber 56 widened, and the cross-sectional area became larger. This shoulder region provided a location for retention and drainage of the wet foam, most likely because the reduction in the upward velocity of the flow of air seemed to allow the flow of wet foam a place to slow down and to become further dewatered and to form a drier foam. After a short residence time in that shoulder region, the drier and lighter foam was observed to be air-lifted up into an uppermost in use region of the exit chamber 56 where it can be captured by over weir flow, or removed from the uppermost end of the exit chamber 56 by the application of active/rapid pulse vacuum suction, resulting in even smaller volumes of concentrated PFAS as the desired waste product.

The inventors have shown that the novel combination of these techniques—the use of a conical-shaped foam fractionation vessel, combined with the use of a narrower exit chamber that is positioned above the conical-shaped vessel—can provide an apparatus for effectively treating trace/ultra-trace PFAS contaminated waters by using the process of foam fractionation.

It is believed that application of a tapered or conical-shaped vessel geometry as the primary foam fractionation chamber is critical to initiate rising air bubble crowding immediately after the introduction of aeration to maximise frothing of trace and ultra-trace feedwaters. The inventors believe that this method of froth formation used in a batch reactor can enhance the formation of froth on/above the water meniscus and therefore maximise the Concentration Factor (CF) of PFAS, and ultimately achieve lower residual PFAS concentration levels after the primary foam fractionation stage is concluded, meaning or further treatment/polishing of the water (for example by the use of ion exchange resins or similar) may not be necessary.

The inventors also implemented a fluid filled bladder 46 which in use can displace water in the fractionation column to effect a lifting of the level of the water column so as to elevate any of the PFAS-rich “sheen” which can sometimes form in the region of the meniscus plus dissolved PFAS which is found concentrated at the head of the water column after a period of vigorous aeration, and yet was insufficiently surface active to produce a froth. Using this feature can improve the removal of very trace amounts of PFAS from the flotation chamber 18.

The bladder 46 can be made of a flexible elastomeric material filled with air or water as the fluid, so that it may expand or contract. In an alternative arrangement, the bladder can operate with a piston-diaphragm style mechanism, mounted to extend into the body of fluid in the chamber 18. The bladder (weather balloon) contains a solid piston inside, and there is water above and air below the device, and the bladder is sealed to the interior chamber walls.

The aim of such a bladder or like device is to effect a 10-15% displacement of the aerated water in the foam fractionation column, and thus push stratified PFAS-containing water into being product.

Once the drained froth layer 32 rises up into the uppermost end of the column 16, a froth removal device can be used to remove the dry froth layer 32 from the exit chamber 56. A froth removal device in the form of a suspended vacuum suction head can be positioned at an optimal distance above the outlet 60 of the exit chamber 56.

In instances where it is desirable to operate at a fixed location within the chamber 18, it is the location of the interface at the DWL 37 which is responsive to changes in the flow of the introduced gas, and/or the water inflow and outflow rates.

In operation, the foam or froth flotation cell 10 can be used to remove a substance such as an organic contaminant from the water being treated. The present disclosure is mainly concerned with the removal of an organic substance known generally as a perfluoroalkyl substance or a polyfluoroalkyl substance (PFAS). This can include one or more of the group comprising: perfluorooctane sulfonate (PFOS); perfluorooctanoic acid (PFOA); perfluoro-n-hexane sulfonic acid, (PFHxS); poly fluorinated carboxylic acids, alkyl sulfonates and alkyl sulfonamido compounds; and fluorotelemeric compounds, each having differing carbon chain lengths; and including precursors of these. The main substances of interest from this group are PFOS, PFHxS and PFOA which can persist in water for a long time.

When the collapsed froth concentrate containing the organic contaminant(s) has been discharged into a separate liquid concentrate receiving container, or knock-out vessel, it is then passed for secondary treatment involving either further concentration, destruction or removal of the contaminant.

In one option for secondary treatment, a final concentrate liquid is treated for removal of the concentrated organic contaminant(s), for example by absorption onto solid or semi-solid substrates (using activated carbon, clay, ion exchange resins or other organic materials), or by filtration (using reverse osmosis membranes to filter and increase the concentration of contaminant(s) and reduce treatment volumes). Once the absorption capacity of a substrate is exceeded it can then be regenerated or destroyed.

Another option for secondary treatment is the further concentration of the collapsed froth may be undertaken using a similar process to that used for the initial separation step and may be conducted in above ground treatment apparatus where the collapsed froth is subject to further gas sparging and froth concentration. Multiple concentration steps may be undertaken using this approach to minimise the volume of fluids requiring treatment. Residual fluids produced during the concentration steps may be re-introduced to the start of the process or, where appropriate, released to a liquid waste disposal/treatment system or to the environment.

The system shown can operate using continuous flow or as a batch process depending on the concentration and nature of PFAS contaminants and co-contaminants. In a continuous flow application, air is introduced to the base of the column 16 and contaminated water is introduced near the uppermost end of each water column, leaving continuously via an outlet in the base below the air inlet (diffuser/sparger or venturi nozzle, etc). Using this approach, a counter current system is established within the column enabling maximum contact between air bubbles and impacted water whilst allowing a continuous processing rate to be achieved.

In a batch application, the column is filled to a predetermined level and this batch is treated within the confines of the column for a fixed period before it is released to the next stage of the fractionation process. Typically this approach is used where longer retention times are required.

Whether the air is introduced into the chamber 18 via a diffuser/sparger, or via venturi nozzle, the result will be the creation of a spectrum of optimally sized bubbles, which rise up through the water within the column 16. The dense bubble stream which is produced, and the high interfacial surface area of the bubbles provides both sufficient mixing agitation as well as a strong attraction for PFAS which may be present in solution in the feed water. The PFAS molecules are quickly scavenged from the water and drawn to the top of the water column. The foam formed at the top of water column is enriched in PFAS and, by using an exit chamber of an extended length (height), or an exit conduit (in the form of a condensation or reflux column, for example), which is located above and arranged to receive said rising froth via the stem of the conical foam fractionation chamber 18, a process of enhanced foam crowding and drainage can occur. Before the foam has a chance to collapse and dissolve back into the water, it can be harvested by a vacuum extraction hood or funnel, and drawn into a centralised collection tank.

By establishing appropriate flow rates (and therefore detention times), the water travelling through the column (now depleted in PFAS) may be discharged through the outlet conduit near the column base and then into a secondary fractionation column for further treatment. Fractionated residual water flowing from the secondary treatment column is directed to a temporary holding tank and, only after further assessment and confirmation of compliance with regulatory guidelines, are they redirected back to a liquid waste disposal/treatment system or released to the environment.

PFAS concentrate/foam resulting from the operation of the conical foam fractionation chamber 18 in combination with an exit chamber or exit conduit of an extended length (height), can be temporarily stored in a “knock-out” vessel 28. This concentrate material can then be processed in one or more further foam fractionation stage(s) before final collection and removal for offsite destruction. Treated water flowing from the base of foam fractionation column 16 may be returned to the primary feed water tank for reprocessing or, where appropriate, redirected to a liquid waste disposal system or released to the environment. Exhaust air from all fractionation columns may be directed through absorptive filters prior to release to atmosphere, to remove VOCs and the like.

### Experimental Details

In an exemplary scaleable process, foam fractionation can be operated with an individual flotation chamber in a batch mode, or multiple chambers. When there are multiple units connected in parallel to one another, they can be arranged to operate in a sequence but at various times which are offset from one another, the result which is achieved is an effectively continuous process. The batch flotation process can be harnessed to maximise the PFAS molecule removal recovery (by their nature, batch processes are operable to exhaustion) as well as be operated in a way so as to maximise the concentration factor (CF) by producing a small volume, dry foam of PFAS waste concentrate.

In a multi-unit operation, vessel filling, fractionation and draining may be undertaken using an exemplary five (5) flotation vessels 18 which are each operable as a batch process stage. The vessels are operated at sequential, spaced apart times, so that by the time the fifth vessel is being filled with untreated feed water, fractionation of the first vessel will have been completed and that vessel will have been drained. This process arrangement still allows for one feed pump to fill all five vessels and one discharge pump to drain all five vessels. The process can be run on a continuous 24/7 basis with fractionation ceasing only for maintenance, or where low groundwater flow rates are experienced which introduces process delays between stages. Such an embodiment is sometimes known as a Sequenced Batch Reactors, or as Continuous Batch flotation in a multi-modal manner, using higher or lower airflow during specific time periods when operating as an aeration device other periods.

### Experimental Results

Experimental results have been produced by the inventors using a laboratory (batch) configuration of the new apparatus and method disclosed herein, to observe any beneficial outcomes during the operation of the process of concentrating PFAS from groundwater samples.

(1) The Inventors have Discovered that Certain Specific PFAS can be Treated (Selectively Removed) by this Technique

| | | |
|---|---|---|
| | | Level of Concern |
| Compound Name | Abbreviation | (Priority/Secondary/Other) |

Successfully Removed by Foam Fractionation
(to either below drinking water criteria or below level of reporting)

| | | |
|---|---|---|
| Perfluorohexane sulfonic acid | PFHxS | Priority |
| Perfluorooctane sulfonic acid | PFOS | Priority |
| Perfluorooctanoic acid | PFOA | Secondary |
| Perfluorononanoic Acid | PFNA | Other |
| Perfuorodecanoic Acid | PFDA/Ndfda | Other |
| 6:2 Fluorotelomer Sulfonate | 6:2 FTS | Other |
| 8:2 Fluorotelomer Sulfonate | 8:2 FTS | Other |

Moderately Reduced by Foam Fractionation

| | | |
|---|---|---|
| Perfluoroheptanoic Acid | PFHpA | Other |

Little effect by Foam Fractionation

| | | |
|---|---|---|
| Perfluorohexanoic acid | PFHxA | Secondary |
| perfluorobutane sulfonic acid | PFBS | Secondary |
| perfluoropentane sulfonic acid | PFPeS | Secondary |

Both of the key priority PFAS compounds of concern (PFOS and PHFxS) can be successfully removed by foam fractionation, and this process was also found to be similarly effective in physically removing PFOA (a secondary priority compound) and four other routinely analysed PFAS compounds. Perfluoroheptanoic Acid (PFHPA) was moderately reduced by foam fractionation. The three other secondary priority compounds (PFHxA, PFBS and PFPeS) were shown to be minimally, or not affected, and thus can be separated from the primary priority compounds using the foam separation which has been developed, if required.
In some embodiments, foam fractionation is ideally suited to physically removing the priority PFAS molecules (including other theoretical non-PFAS co-contaminates), therefore allowing more sophisticated (and expensive) techniques to be reserved as polishing treatments to achieve concentrations below criteria for regulated disposal or discharge.
   (2) The Inventors have Discovered that Other Contaminants be Treated with this System
The physical separation technique described herein is designed to optimise the creation of a contaminant rich extractable foam within a fractionation column. Co-contaminants effectively treatable by this same process include:
   Total Petroleum Hydrocarbons (TPH), including benzene, toluene, ethylbenzene and xylene (BTEX);
   Halogenated Volatile Organic Compounds (VOCs), including 1,2-dichloroethane (DCE), 1,1-dichloroethane, trichloroacetic acid (TCA), tetrachloroethylene (PCE), and trichloroethylene (TCE)
   Non-petroleum Hydrocarbons (methanol and isopropyl ether)
Other contaminants which will also be reduced include: Acetone, PAHs (naphthalene, and 2- and 3-ring PAHs), MTBE, MIBK, MEK. The specifics of co-contaminant reduction using foam fractionation are undergoing lab/field trial evaluations.
   (3) Experimental Work Using a Conical Vessel which is Connected to an Uppermost, Further Chamber for Foam Drainage, and Discovering that Specific PFAS-Contaminated Waters can be Treated by this Technique

The present Applicant has a commercially proven SAFF40™ treatment process operating since May 2019 at Army Aviation Centre Oakey (AACO), Queensland, Australia. This facility has successfully removed PFAS contaminants from groundwater to concentrations which are below both Defence Department and NEMP (2018) Australian Drinking Water Guidelines (ADWG's) from impacted groundwater (GW) characterised with a total detectable TD-PFAS influent concentration of 6.5 g/l (this was a 12-month average figure). Feedwater with this input concentration of PFAS consistently produces sufficient primary foamate from the primary fractionator which, in turn, was then fed to a secondary fractionation stage, to result in an overall Concentration Factor (CF) of approximately 7400 (which, for example, exceeds the CF associated with GAC filtration of approximately 5000).

An improved primary foam fractionation process is especially important to enable the treatment of trace and ultra-trace PFAS-impacted waters, to remove the concentration of PFAS present to be below drinking water standards. Without a primary concentration step that is performing satisfactorily, the subsequent concentration steps cannot occur to their maximum extent.

The present inventors observed how, in the primary foam fractionation stage using a conical-shaped foam fractionation vessel, the rising air bubbles will crowd into the column neck right after the commencement of aeration of the foam fractionation water column. The specific parameters (independent variables) which were studied included the geometric shape of the primary foam fractionation vessel, and the shape and configuration of the dry foam exit chamber or conduit, which is connected to, and located above that fractionation vessel, in use.

The test work included the use of video and photography for verification, and by sampling and testing using NATA/ISO-17025 accredited laboratories employing USEPA method 537 with compliance to QSM 5.2.

One experiment involved initiation of enhanced crowding of rising air bubbles within the water column to obtain a PFAS-rich froth, which was sufficiently thick and strong enough to transform into a wet foam which rose upwardly above the air-water interface (or meniscus). This was achieved by continually narrowing the diameter of the foam fractionation column over its height, extending between the lowermost edge (base) and a region just below the uppermost edge (or stem). In one example, a conical-shaped foam fractionation column, having a progressively smaller, circular, internal cross-sectional shape when moving over its height from bottom to top, functioned in use to confine the rising foam volume into an ever smaller cross-sectional area, until reaching the region just below the stem of the uppermost opening. This confinement appeared to allow the foam to become thicker and then, by being stable enough to bridge the width of the stem, the foam or froth was then able to more effectively rise upward, for harvesting and removal from the column.

Further experiments were aimed at testing the effectiveness of continual aeration of the froth or wet foam during its rise upward out of the conical-shaped column. The inventors observed that the wet foam will become drier when it is located within an exit chamber of an extended length (height), or an exit conduit (in the form of a condensation or reflux column, for example), being located above the foam fractionation column and arranged to receive said froth via the stem of the conical foam fractionation vessel. It is believed that the upward flow of gas into the exit chamber can cause enhanced collapse of the wet froth by the drainage of the interlamellar film, as well as the evaporation displacement of water, resulting in an increased rate of bursting of the froth air bubbles. Such further dewatering of the wet foam can produce a more desirable thicker, drier foam. This type of foam is then more easily harvested in a flow of concentrate which either spills over a weir/launder, or via a vacuum suction foam extraction method, to further increase the PFAS concentration factor in the removed foamate.

The inventors have shown that the novel combination of these techniques—the use of a conical-shaped foam fractionation vessel, combined with the use of a narrower reflux tube that is positioned above the conical-shaped vessel—can provide an apparatus for effectively treating trace/ultra-trace PFAS contaminated waters by using the process of foam fractionation.

It is believed that application of a tapered or conical-shaped vessel geometry as the primary fractionation column is critical to initiate rising air bubble crowding immediately after the introduction of column aeration to maximise frothing of trace and ultra-trace feedwaters. OPEC suspects that earlier froth formation used in a batch reactor shall provide enhancement to the formation of a wet/dry foam on/above the water column meniscus and therefore maximise foam removal, PFAS Concentration Factor (CF) and ultimately achieve lower PFAS concentration treatment levels in the primary fractionation treated water ear-marked for disposal or further treatment/polishing.

### Experimental Equipment

The experimental equipment used was a 5 L glass flat-bottom conical flask filled with 5 L of PFAS impacted groundwater. The 5 L flat-bottom conical flask was fitted uppermost with a 150 mm glass reflux column with a diameter of 20 mm to prevent spillage. The flat-bottom conical flask with reflux column was setup along-side a 10 L conventional, circular, cylindrical foam fractionation column, which was filled in use to the 5 L mark as a control/comparison.

In these experiments, the following conditions were applied:
Control Variables: water volume, water temperature, PFAS influent concentration/formulation, native water chemistry (ie. pH, EC, salinity, TSS, etc), mode of aeration, laboratory temperature/humidity/atmospheric pressure, air flow and pressure.
Independent Variables: foam fractionation vessel geometry, shape/length of exit chamber (e.g. reflux column); and time required to aerate the wet foam in the exit chamber prior to removal therefrom (by flowing over a weir or by vacuum suction) for harvesting of a PFAS concentrate.
Dependent Variables: progressive formation of a froth at the meniscus, followed by transition into a wet foam and then a stable persistent drier foam of significant height within the exit chamber prior to removal therefrom (by flowing over a weir or by vacuum suction) for harvesting of a PFAS concentrate.

Initially, the reflux column was fitted to the top of the 5 L flat-bottom conical flask as a precautionary safety apparatus to prevent PFAS-rich wet foam or air/water interfacial bubbles spilling from the 5 L flask. However, during experimentation, the reflux column was observed to assist in the evaporation of water to form dry foam at room temperature. An improved result was observed where the froth/wet foam appeared to be aided by a shoulder region moulded into the base of the reflux column where the column became a little wider in cross-sectional area. This shoulder region provided a location for retention and drainage of the wet foam (typically for a residence time of around 10-20 minutes).

The present foam fractionation columns are designed to remove PFAS from water by operating in a batch mode application where the primary fractionator can aerate PFAS impacted waters across a variable duration (from as little as 10 minutes to a few days). More typically, froth and wet foam is aerated for 20-60 minutes to evaporate excess water to produce a drier foam and extremely high CF. An aeration dwell time of at least 15-20 minutes is required to remove PFAS compound suite (ie. PFOS, PFOA and PFHxS), as listed under the Stockholm Convention.

Shorter chain PFAS compounds are under increasing toxicological and regulatory scrutiny and possible listing under the Stockholm Convention as being required for elimination and/or restriction. This would require additional aeration dwell time with smaller rising air bubbles (ie. greater surface area of thin air/water interfacial adherence zone) for uptake by the smaller, more soluble, short-chain PFAS molecules.

The aforementioned process can facilitate the managed removal of trace and ultra-trace PFAS concentrations found in a wide range of global contaminated sites using a physical separation/concentration methodology without the need for adsorbents or other consumables that become secondary waste streams. By offering an improved primary fractionation performance, the system has capabilities which allow for significantly increased versatility.

### Experimental Objectives

The experimental objectives were:
removal of priority PFAS molecules to less than drinking water criteria with testing by ISO-17025 accredited laboratories reporting LOR of 0.001 μg/l;
obtaining a PFAS Concentration Factor (CF) of greater than 50-100 by use of the experimental primary fractionation vessel (ie. flat-bottom conical flask geometry, fitted with upper reflux chamber/column); and
devising a cost-efficient methodology that can be scaled-up to treat typical volumes and concentrations of site water impacted by PFAS; and
devising a way that foam fractionation can be used for removal of trace and ultra-trace PFAS contamination levels in contaminated waters (<1 μg/l).

Experimental observation/findings were based on feedwater impacted with legacy AFFF total detectable PFAS (3-25 μg/l), comprising AACO site water spiked with additional concentrated AFFF formulation).

### Conventional Cylindrical Fractionation Column

The addition of concentrated AFFF (source: 3M Lightwater) was added to 5 L of AACO site water to obtain a final fractionation column concentration of approx. 25 μg/l (actual concentration confirmed by laboratory analysis was 24.5 μg/l TD-PFAS by modified USEPA Method 537).

The fractionation column was then aerated over a 20 minute experimental period. At the completion of the aeration period, a thin layer (1-5 mm) of aerated bubble mass was formed at the meniscus which was observed to collapse relatively instantly after the aeration energy in the base of the fractionation column ceased.

Harvest of the foamate (actually a bubble mass pre-foamate) was achieved by increasing the air flow rate supplied by the air pump to lift the top of the fractionated water column up and to spill over the weir and into the fractionator collection cup. Refer to Table 1 for detailed results.

### Conical Cylindrical Fractionation Column

The addition of concentrated AFFF (source: 3M Lightwater) was added to 5 L of AACO site water to obtain a final concentration within the conical flask of approx. 25 μg/l (actual concentration confirmed by laboratory analysis was 21.6 μg/l TD-PFAS by modified USEPA Method 537). These experiments using the conical flotation chamber 18 were conducted alongside the conventional cylindrical fractionation column to provide a video comparison record.

A reflux column (being a hollow chamber of extended length) was fitted to the top of the conical flask to prevent foam spilling out of the vessel. The conical flask and conventional fractionation column were both aerated over a twenty-minute period. A thicker/crowded aerated mass formed (10-20 mm) at the meniscus within first 3-5 minutes, followed by a froth that began to form after approx. 10 minutes which then lifted up into the base of the reflux column. Continued aeration resulted in a froth forming at 12 minutes in the base of the reflux column which seemed to begin to stick to the reflux column glass wall and become a wet foam. After 17 minutes a drier foam began to form which included foam spheres being ejected above the dry foam reach half height of the 150 mm long reflux column.

An unexpected result was observed that seemed to show excess water draining from the conical flask neck where the froth was being crowded, and back into the conical flask whilst water content in the froth/wet foam interfacial zone was undergoing a continuous evaporation process of bursting of bubbles/froth to form the light dry foam capable of ejecting foam higher into the reflux column.

Once the fractionation experiment was concluded, the final foamate layer was significantly thicker at the meniscus and sticking to the glass walls of both the neck of the conical flask and within the base of the reflux column. The dried foam and aerated froth remaining at the meniscus was then spilled over the weir by increasing the air pump air flow rate. Refer to Table 2 for detailed results.

The application of heat to the upper region of the conventional shaped cylindrical column and to the neck region/bottom of the reflux column of the conical vessel 18 was carried out to assess if there were any observable increases in the rate of aerated bubbles transitioning into a froth, wet foam and finally dry foam (i.e. air/water interfacial partitioning above the meniscus, however there were no notable increases observed in the concentration of PFAS, nor observable increases in foam formation (the ambient temperature within the laboratory was approx. 21 C).

### Discussion of Experimental and or Field Trial Results

Tables 3 and 4 indicate the concentration factors required for effective treatment of trace and ultra-trace impacted waters when using “conventional” SAFF foam fractionation (as developed by the present Applicant) which employs the known primary separation followed by secondary/tertiary reconcentration processes.

We concluded that if the conical geometric shape is able to obtain a primary fractionation concentration factor of >250×, then TD-PFAS (ultra-trace) impacted feedwaters of 0.1-0.5 g/l may be able to undergo successful SAFF40 foam fractionation processing. At feedwater concentrations of less than 0.1 μg/l TD-PFAS, it may be that AIX resin treatments are likely to be more economical.

The typical classifications of a PFAS contaminated source is as follows:
PFAS source zone high concentrations: 100-2000 μg/l,
PFAS migration zone medium concentrations: 25-100 μg/l,
PFAS up-gradient, boundary zone low concentrations: 5-25 μg/l,
PFAS trace concentrations: 0.5-5 μg/l
PFAS ultra-trace concentrations: 0.01-0.5 μg/l

During the experiments, once aeration activated, then after 45 seconds neither the conventional cylindrical flotation column, nor the flat-bottom conical flask column 18, had developed any persistent foaming on the meniscus, although the aerated bubbling mass at the meniscus was significantly more pronounced in the conical flask 18 when compared to the conventional column.

Reflux is a technique normally involving the condensation of vapours and the return of this condensate to the system from which it originated, usually when the system is heated to near/at boiling point. Use of the reflux column for the creation of a dry PFAS-rich foam concentrate came about when the reflux column was fitted to the top of the 5 L flat-bottom conical flotation chamber 18 as a means to prevent PFAS-rich wet foam or air/water interfacial bubbles flowing from the 5 L flask. However, during experimentation, the reflux column was observed to assist in the evaporation of water to form dry foam at room temperature.

A conical flask model test unit has been labelled in FIG. 31 to illustrate and explain what was observed and, where such observations were noted within the spatial configuration of the flat-bottom conical flask fitted with reflux column, to aid understanding of PFAS removal from water column as a froth, then wet foam and finally dry foam containing concentrated PFAS compounds.

These SAFF units are effectively operating in batch mode, to extract the maximum recovery of PFAS into the foam concentrates (see FIG. 31). The flat-bottom conical flask geometry crowds rising air bubbles (and PFAS molecules) within the water column above it by using a continuously reducing volume. Micelles form just below the meniscus, included in the lift up into the chimney and reflux column where water continually drains back into the flask, and evaporation forms foam above the reflux column shoulder for harvesting by vacuum or spill-over weir.
Zone 1—foam trap—height 50 mm. dry foam is able to hold position about the reflux column shoulder.
Zone 2, wet foam (froth), plus air-water interfacial portioning/migration zone. Water constantly lifts and falls between reflux column and meniscus in flask, for further cyclical dewatering
Zone 3 air water interfacial partitioning zone where long-chain PFAS molecules accumulate (separate from the water column)
Zone 5—formation of micelles within the crowded flask geometry
Zone 6—water column aeration zone

The foamate started to hold its shape at 18-20 minutes with assistance from the glass shoulder of the reflux column to prevent stabilised foam from sliding back into flat-bottom conical flask whilst under aeration.

Additional heating of Zones 1 & 2 with a hand-held heat gun failed to produce any significantly notable/observable observation compared to the conical flask crowding and reflux column drying of wet foam. An alternative experimental procedure shall be required to investigate evaporation of water from the air/water interfacial zone thought to transform wet loose foam into a more stable dry foam for harvesting by vacuum to minimise the collection of the PFAS-rich waste fraction for transportation to a permanent waste destruction facility (or on-site destruction by electrochemical oxidation cells requiring extremely low volumes/high concentrations to offer economic viability).

Functional Features of the Apparatus which Support a Weak Foam

The design of conical internal shape foam fractionation vessel has application in the treatment of very low levels of PFAS contamination, with a vessel geometry arranged to focus foam creation into an increasingly crowded volume before passing the concentrate into the drainage column from which it flows over a launder or can be vacuum extracted.

The use of pulse aeration (to remove slugs of dried foam), extended height reflux columns (to manage high-expansion foams) and potentially cooling the water column can make short-chain PFAS molecules less soluble (to aid their recovery) are all ways in which the operation of the apparatus may be enhanced.

It appears that the flat-bottom conical flotation chamber 18 has a geometrical shape which offers an improved crowding effect of the rising air bubbles, leading to bubble coalescence, and allowing a weaker foam formed from very dilute or trace amounts of a surface active PFAS substance to more effectively bridge the narrow opening at an upper end of the flotation chamber.

It is also believed that because the velocity of gas moving through the opening at the upper end of the flotation chamber is relatively faster than the airflow in a conventional cylindrical flotation column (due to gradually narrowing chamber width) leading into elongate/reflux chamber, and that this can have a substantial drying effect on the PFAS compounds which have been removed in the wet foam leaving the primary fractionation chamber.

Recommendations Arising from Experimental and or Field Trial Results

The use of a primary fractionation process using the 5 L glass flat-bottom conical vessel 18 fitted with an 150 mm long reflux column can remove PFAS contaminants sufficiently well to be able to leave a body of treated water which can meet all drinking water standards. In addition, the following points offer commercial advantage to the SAFF process:
(1) The conical primary fractionation stage offers opportunity to treat environmental and process waters with lower influent PFAS concentrations (ie. 0.1 μg/l to 1 μg/l),
(2) The conical primary fractionation stage offers an opportunity to transition the trace and potentially ultra-trace PFAS concentrations in influent waters into the PFAS first concentrate range required by the existing secondary fractionation stage without encountering over-concentrating during the final tertiary fractionation stage,
(3) Primary fractionation employing the conical geometry to crowd rising air bubbles within the water column is the stage that can increase the overall SAFF concentration factor an order of magnitude or greater without affecting the efficacy of the proven secondary and/or tertiary fractionation stage sub-processes.
(4) The use of the water lift methodology to remove stratified PFAS from the aerated water column (for example the air-filled/water-filled bladder) could also be used in combination with an aeration pad/disc which is connected to the inflatable bladder along with a number of air inlet venturis to potentially overcome the difficulties in removing the short-chain PFAS compounds that remain/partially remain in the fractionation column after treatment.

The apparatus and methodology can also be applicable to of certain non-PFAS co-contaminants such as:
Volatile Halogenated Compounds (VHC's: including TCE, PCE, 1,2-DCE, VC),
Volatile Total Recoverable Hydrocarbons (vTRH's),
Pesticides,
Micro-plastics
Non-PFAS containing foams used in fire-fighting training and other industries,
Persistent Organic Compounds (eg. Dioxins, Furans & PCB-like dioxins)
Brominated Flame Retardants (BFR's such as PBDE's, PBB, HBCDD, TBBPA),
Environmental Persistent Pharmaceutical Pollutants (EPPP's), and
Pharmaceutical and Personal Care products (PPCP's).

Depending on the application, the methodology can also be operated to maximise its performance by changing various parameters such as temperature, humidity, atmospheric pressure, salinity, pH as well as the use of transition metal ions as activators which can enhance the foam separation of perfluorooctanonic surfactants (for example, in one study, perfluorooctanonic surfactants had >99% removal efficiency using 11.5 mM of Fe(III) in 5 minutes). Also, acidic pH, e.g., 2.3 favour the foam separation of perfluorooctanonic surfactants, so that in one study, adjusting the pH of the foamate to 7.0, meant that only 84-91% of perfluorooctanonic surfactants were then recovered.

### (4) Further Modification of the Foam Fractionation Method to Extract Shorter Chain PFAS Substances

The foam fractionation experiments given thus far were designed to remove PFAS from water by operating in a batch mode application where the primary fractionator can aerate PFAS impacted waters across a variable duration to remove PFAS compound suite (ie. PFOS, PFOA and PFHxS), as listed under the Stockholm Convention.

The removal of shorter chain PFAS compounds which typically comprise more soluble, and less surface-active molecules can also be removed to achieve trace and ultra-trace PFAS concentrations by using the conical primary foam fractionation apparatus in conjunction with the staged addition of a surfactant to increase the stability of a resultant foam/froth which is formed. The experimental procedure was as follows:
(1) Fill the high-performance fractionation column (conical shaped vessel 18) with approx. 15 L PFAS contaminated water.
(2) Begin aeration using either a 20 cm diameter aeration disc with/without additional venturi aeration applicators (this experiment data without additional venturi aeration) for—
   a. 60 mins with sampling just above the aeration disc with syringe fitted with 5 mm HDPE tubing at Time Zero (T₀), T₅, T₁₀, T₂₀, T₃₀, T₄₅, and T₆₀ mins.
   b. An additional 60-80 mins of aeration flotation, but this time with the addition of common household anionic surfactant added (10,000× dilution in 15 L) with sampling at Time Zero (T₀), T₅, T₁₀, T₂₀, T₃₀, T₄₅, and T₆₀ mins.
   c. Sampling of foamate product which is collected from the spill-over weir at the top of the reflux column at 60 mins, 120 mins 165 mins (sT₁₆₅ means surfactant added and foamate sampled at time 165 mins of aeration).

The results shown in Table AA clearly demonstrated the efficacy of the method in removing short chain PFAS substances (propanoic/propane; butanoic/butane; pentanoic/pentane; hexanoic/hexane, etc.). When the surfactant (which can be an anionic, cationic or another bio-surfactant) is added into the water filled inside the foam fractionation column, it functions to “collect” highly soluble, very low adsorption isotherms to be taken up onto the air/water interfaces of the rising air bubbles. The functional purpose is for the surfactant to attach to short chain PFAS (<C6 molecules) to increase the adsorption isotherm constant, resulting in removal of the combined surfactant+short chain PFAS molecules. In each circumstance, the attachment of the short-chain PFAS molecules to a surfactant/collector will depend on the chosen reagents, but such attachment can be via weak bonding (such as Van der Waals forces) and/or ionic bonding. All collector/surfactant should be readily removed as a product in the foam flotation process either by reaching the spill-over weir, or perhaps removed from the reflux column via the vacuum foam removal process.

### General Advantages of the Process and Apparatus

From the above, it will be understood that at least some embodiments of apparatus and method in accordance with the present inventions provide one or more of the following advantages, in comparison to conventional treatment methods:
A lower volume of PFAS concentrated liquor is produced for secondary treatment steps;
A smaller secondary treatment plant is required;
A lower overall treatment time is achieved compared to standard “pump and treat” systems;
A smaller volume of concentrated liquor means that use of a complete destruction process (not disposal to landfill) is feasible;
The method has the ability to extract contaminant from water pumped out of contaminated ground instead of performing in-situ chemical treatment, which may not work (or be reversible), and may not reach all levels of groundwater contamination.
The apparatus can be configured for use in many different types of remediation situations, including source zones, hotspots, migration pathways—it is possible to adjust a few simple variables such as vacuum suction, distance from the suction apparatus to liquid-froth interface, and the flotation airflow rate, and deal with any concentration of contaminant.
The system can be expanded easily to meet specific site requirements as the fractionation columns, pumps, vacuum systems, pipework and connections are comprised of standard componentry, expansion is simply a matter of replicating systems in parallel, and pump and blower sizes may be adjusted (up or down) to meet the changed requirements.
A physical separation process external to the ground avoids the use of potentially hazardous chemicals as part of in-situ chemical treatment approaches, and produces no by-products or wastes.
Depending on the start concentrations, vacuum extraction experiments have created concentrates between 1/10 to 1/45 of the original fluid volume and a residual process water essentially devoid of PFAS.
Subsequent re-fractionation of concentrates (and amalgamation of clean process waters) creates hyper-concentrates that bring overall reduction ratios to approx. 1/400 of original fluid volume.
The vacuum extraction approach also allows for the following performance improvements:
   The PFAS foam breaks during the extraction process and creates a fluid with few bubbles.
   The height of reflux column can easily be adjusted to minimise extraction of “wet” foam, giving too much carryover water and dilution.
   The use of some form of suction extraction transports the resulting PFAS rich liquid concentrate out from the top of the fractionation vessel, and/or out of the reflux column, which unlike conventional particle flotation or other foam fractionation is not directly transporting a volumetric flow out of the primary vessel (for example by flow/pouring over a weir).

Throughout this specification, the words “froth” and “foam” may be used interchangeably but are taken to mean the same thing, essentially comprising a wet liquid concentrate having low quantities of particulate materials or concentrated organic contaminants, and extracted by various designs of devices which aim to provide as much control and reduction of the water content in the froth layer as possible.

In the foregoing description of certain embodiments, specific terminology has been resorted to for the sake of clarity. However, the disclosure is not intended to be limited to the specific terms so selected, and it is to be understood that each specific term includes other technical equivalents which operate in a similar manner to accomplish a similar technical purpose. Terms such as “upper” and lower”, “above” and “below” and the like are used as words of convenience to provide reference points and are not to be construed as limiting terms.

The reference in this specification to any prior publication or information is not, and should not be taken as, an acknowledgement or admission or any form of suggestion that the prior publication or information forms part of the common general knowledge in the field of endeavor to which this specification relates.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

In addition, the foregoing describes only some embodiments of the invention(s), and alterations, modifications, additions and/or changes can be made thereto without departing from the scope and spirit of the disclosed embodiments, the embodiments being illustrative and not restrictive.

Furthermore, invention(s) have described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention(s). Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment.

1. A method of separating trace amounts of amphiphilic substances from water which is contaminated with the substances, the method comprising the steps of:
admitting an amount of the water, which includes an initial concentration of the substances, into a chamber via an inlet thereinto, the chamber being, at least in part, conically shaped by having a progressively smaller internal cross-sectional area when moving in an upward direction over its vertical height;
introducing a flow of gas into the chamber, wherein said introduced gas forms gas bubbles and induces the water in the chamber to flow, to produce a froth layer which is formed at, and which rises above, an interface with the said flow of water and of introduced gas in the chamber, the froth layer including an amount of water and also a concentrated amount of the substances when compared with their initial concentration; and
removing at least some of the froth layer from an upper portion of the chamber,
wherein in use, the method involves operably controlling the location of the interface at a vertical height in the conically shaped part of the chamber, to result in conditions where:
the rising air bubbles experience crowding and coalescence in the water below the interface, enhancing formation of the froth layer, to thereby influence recovery of the substances therein; and
the cross-sectional flow path of the froth layer which rises above the interface becomes confined near the upper portion of the chamber, resulting in drainage of water from the froth layer to thereby influence the concentration of the substances therein.

2. The method as claimed in claim 1, wherein the flow of gas and the production of the froth layer is continuous.

3. (canceled)

4. The method as claimed in claim 1, wherein operably controlling the location of the interface is achieved by using a flow controller and an inlet valve for controlling the flow of said introduced gas into the conically-shaped chamber.

5. The method as claimed in claim 1, comprising a further step for drainage of water from the froth layer in which a second chamber is arranged to extend upwardly from the conically-shaped chamber, in use to receive the froth layer as it leaves the conically-shaped chamber, and to facilitate froth drainage.

6. The method as claimed in claim 39, wherein the further step comprises the use of said second chamber when arranged to extend above the conically shaped chamber in a vertically upward direction.

7. (canceled)

8. The method as claimed in claim 5, wherein any froth layer remaining is collapsed during a removal step from an upper portion of the second chamber, and prior to undergoing a secondary treatment step.

9. The method as claimed in claim 8, wherein the froth layer remaining is collapsed by using a mechanical apparatus selected from the group comprising: a foam breaker, a vacuum extraction device, and a froth extraction head.

10. The method as claimed in claim 9, wherein the secondary treatment step, for treating the collapsed froth layer that includes the concentrated substances, uses at least one of the processes selected from the group comprising: absorption (using activated carbon, clay, or ion exchange resins), filtration (using reverse osmosis membranes); and introduction of further quantity of gas into a separate containment apparatus to produce another flotation froth layer comprising a further concentrated amount of the substances.

11-13. (canceled)

14. The method as claimed in claim 1, wherein the substances are organic.

15. The method as claimed in claim 14, wherein the trace amphiphilic substances are at least one of a perfluoroalkyl substance or a polyfluoroalkyl substance (PFAS).

16. The method as claimed in claim 15 wherein the perfluoroalkyl or polyfluoroalkyl substances (known as PFAS) includes one or more of the group comprising the following primary amphiphilic substances:
perfluoro-octane sulfonate (PFOS); perfluoro-octanoic acid (PFOA); perfluoro-n-hexane sulfonic acid (PFHxS); perfluoro-nonanoic acid (PFNA); perfluoro-decanoic acid (PFDA/Ndfda); 6:2-fluorotelomer sulphonate compounds (6:2 FTS); 8:2-fluorotelomer sulphonate compounds (8:2 FTS); and perfluoro-octanoic acid (PFHpA); poly fluorinated carboxylic acids, alkyl sulfonates and alkyl sulfonamido compounds; and fluorotelemeric compounds, each having differing carbon chain lengths; and including precursors of these.

17. Apparatus for separating trace amounts of amphiphilic substances from water which is contaminated with these substances, the apparatus comprising:
a chamber having an inlet which is arranged in use to admit thereinto an amount of the contaminated water which includes an initial concentration of the substances, the chamber being, at least in part, conically shaped by having a progressively smaller internal cross-sectional area when moving in an upward direction over its vertical height;
a gas introduction device which in use admits gas into the chamber, wherein the introduced gas forms gas bubbles and induces the water in the chamber to flow, to produce a froth layer which is formed at, and which rises above, an interface with the said flow of water and introduced gas in the chamber, the froth layer including an amount of water and also a concentrated amount of the substances when compared with their initial concentration; and
a removal device in use for removing at least some of the froth layer from an upper portion of the chamber,
wherein the apparatus is arranged in use with the interface operably located at a vertical height in the conically shaped part of the chamber resulting in conditions where:
the rising air bubbles experience crowding and coalescence in the water below the interface, enhancing formation of the froth layer thereat; and
the cross-sectional flow path of the froth layer which rises above the interface is confined near the upper portion of the chamber, resulting in drainage of water from the froth layer, to thereby influence the concentration of the substances therein.

18-19. (canceled)

20. Apparatus as claimed in claim 17, for the in use control of the location of the interface in the chamber comprises a flow controller and an inlet valve on a gas delivery line.

21. Apparatus as claimed in claim 17, further comprising a froth layer drainage device in the form of a second chamber which is arranged to extend upwardly from the conically-shaped foam fractionation chamber and to receive the wet froth as it leaves the chamber to facilitate further froth drainage, and prior to a secondary treatment step.

22. (canceled)

23. Apparatus as claimed in claim 17, wherein collapsed froth is removed from the second chamber by a froth layer collapse device which includes mechanical apparatus selected from the group comprising: a foam breaker, a vacuum extraction device, and a froth extraction head.

24. Apparatus as claimed in claim 17, further comprising a secondary treatment device in use for treating the collapsed froth layer for removal of the concentrated substance, wherein the treatment device includes at least one of the group comprising: absorption (using activated carbon, clay, or ion exchange resins), filtration (using reverse osmosis membranes); vacuum distillation; drum drying; and introduction of further quantity of gas into a separate containment apparatus to produce another froth layer comprising a further concentrated amount of the substance.

25-33. (canceled)

34. An apparatus for separating trace amounts of an amphiphilic substance from water which is contaminated with the substance, the apparatus comprising:
a conical chamber, configured with a progressively smaller, circular internal cross-sectional shape when moving in a vertical direction up a central vertical axis thereof; and
the chamber having an inlet which is arranged in a lowermost region thereof, and arranged in use to admit thereinto an amount of the contaminated water which includes an initial concentration of the substance;
a gas introduction device which in use admits gas into the chamber, the introduced gas for inducing water to flow within the chamber, and for producing a froth layer which is formed at, and which rises above an interface with the said flow of water and introduced gas in the chamber, the froth layer including an amount of water and also a concentrated amount of the substance when compared with its initial concentration;
wherein the apparatus is arranged in use to confine the froth layer near an uppermost narrow width portion of the chamber, and in so doing, to control the water content of the froth layer, which rises above the interface and passes through the narrow width portion, to influence the concentration of the substance therein; and
a device for removing at least some of the froth layer from the upper portion of the chamber.

35-38. (canceled)

39. The method as claimed in claim 5, wherein the further step for drainage of water from the froth layer comprises the use of said second chamber when in the form of an elongate conduit or a column which is configured to achieve gravity drainage and/or evaporative displacement of water from the froth layer which flows thereinto, to produce a thicker and drier froth concentrate.

40. The method as claimed in claim 5, wherein the further step for drainage of water from the froth layer comprises the use of said second chamber when having an internal shape which is configured to achieve gravity drainage and/or evaporative displacement of water from the froth layer which flows thereinto.

41. The method as claimed in claim 40, wherein the further step comprises the use of said second chamber when having an internal shelf or shoulder region where the internal bore diameter becomes widened, thereby increasing the cross-sectional area and slowing down the rate of froth layer passing therealong, which assists drainage thereof.

42. Apparatus as claimed in claim 21, wherein the second chamber is an elongate conduit or a column which is configured in use to achieve gravity drainage and/or evaporative displacement of water from the froth layer which flows thereinto, to produce a thicker and drier froth concentrate in use.

43. Apparatus as claimed in claim 42, wherein then second chamber has an internal shape which is configured to achieve gravity drainage and/or evaporative displacement of water from the froth layer which flows thereinto in use.

44. Apparatus as claimed in claim 42, wherein the internal shape comprises an internal shelf or shoulder region where the internal bore diameter becomes widened, thereby increasing the cross-sectional area and slowing down the rate of froth layer passing therealong in use.

45. A method of separating amounts of primary and secondary amphiphilic substances from water which is contaminated initially with a mixture of said substances, the primary amphiphilic substances being of relatively longer molecular hydrocarbon chain lengths=>C8 compared with the secondary amphiphilic substances=<C6, the method comprising the steps of:
introducing a flow of gas into a vessel containing the contaminated water, aiming to produce a froth layer which rises above an interface with said water and gas flow, so that the froth layer includes an amount of water and a concentrated amount of the primary amphiphilic substances when compared with its initial concentration, which is then removed; and
continuing to introduce the flow of gas into the vessel containing the contaminated water, to allow a steady-state enrichment of the amphiphilic compounds to occur in the surface meniscus region of the flotation vessel; and then
introducing an upward, volumetric displacement of some of the water within the flotation vessel, to thereby release any remaining primary amphiphilic substances, and a concentrated amount of the secondary amphiphilic substances when compared with its initial concentration, which is then removed from the vessel.

46. A method as claimed in claim 45, wherein the upward volumetric displacement of some of the water in the flotation vessel to remove stratified contaminant amphiphilic compounds within it involves lifting up the top of the fractionated water column so it spills over a weir, using of one or more of the following water lift devices:
an air-filled/water-filled bladder, an aeration pad/disc, air inlet venturis and an air pump.
